(19) United States
(12) Patent Application Publication
(10) Pub. No.: US 2008/0285686 A1
(43) Pub. Date: Nov. 20, 2008

(54) Antenna Selection Apparatus and Methods

(76) Inventors: Norman Beaulieu, Edmonton (CA); Wenyu Li, San Jose, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/997,103

(22) PCT Filed: Jul. 31, 2006
(86) PCT No.: PCT/CA06/01245

§ 371 Date: Jan. 28, 2008

Related U.S. Application Data
(60) Provisional application No. 60/703,418, filed on Jul. 29, 2005.

(51) Int. Cl. H04L 27/22

(52) U.S. Cl. 375/329; 455/226.3

(57) ABSTRACT

An apparatus and method for antenna selection diversity are provided. Antennas are selected by summing moments of space-time block encoded signals received via each respective antenna and selecting at least one antenna with the largest moment sum.

### RELATED APPLICATION

The present application is related to and claims the benefit of U.S. Provisional Application No. 60/703,418, filed Jul. 29, 2005, entitled “ANTENNA SELECTION APPARATUS AND METHODS”, which is hereby incorporated by reference in its entirety.

### FIELD OF THE INVENTION

This invention relates generally to wireless communications and, in particular, to antenna selection.

### BACKGROUND

The Alamouti scheme is an important wireless transmitter diversity technique. It is part of the 3G standard (both IEEE 802.16 and IMT 2000), which represents the future of broadband wireless service. With two transmitter antennas, it is proven to provide much better system performance than systems with only one transmitter antenna. The 3G standard uses it to implement the downlink transmission from mobile stations to mobile terminals or the transmission specification for mobile base stations. Thus, mobile terminals, such as mobile phones, wireless PDAs, WiFi computers, etc., must implement receiver designs using Alamouti schemes. With more than 500 million handheld devices around the world as of 2005, a novel and economical mobile terminal receiver design can create a huge impact on the global wireless market.

However, all existing receiver designs which support the Alamouti transmission scheme use either the maximal ratio combining (MRC) technique or the conventional selection combining (SC) method. With MRC or SC, a receiver having L antennas and L receiver branches has to estimate the channel gain and/or signal-to-noise ratio (SNR) information for all the L receiver branches. As a result, there are implementation and design costs associated with building this additional circuitry. Furthermore, in normal operation, this circuitry consumes additional power, which can be problematic for limited-power applications such as in mobile communication devices. The channel knowledge requirement also makes the existing schemes subject to deterioration in performance (lack of robustness) when the estimated channel information or signal-to-noise ratio information is inaccurate.

There remains a need for receive antenna selection schemes which provide for simpler receiver hardware implementations and reduced power consumption while still retaining good system performance.

### SUMMARY OF THE INVENTION

According to one broad aspect, the invention provides apparatus for selecting N communication signals from a plurality M of communication signals received via respective antennas containing a length L space-time block code STBC, where M≧2, M>N≧1, L≧2, the apparatus comprising a selector configured to: for each receive antenna, determine a respective moment of a raw signal plus noise sample of the communication signal received on the receive antenna for each of L time intervals of a block code duration and sum these moments to produce a respective moment sum; and select the N communication signals that have the N largest moment sums for subsequent communication signal processing.

In some embodiments, the selector comprises a plurality of moment calculators for respective connection to a plurality of communication signal receiver branches comprising the respective antennas, and configured to calculate the sums of moments of the communication signals received through the plurality of communication signal branches.

In some embodiments, the communication signals received through an i^{th} communication signal receiver branch comprise diversity signals r_{j,i} received from transmitter antennas during j=1, . . . , L time intervals of an STBC block code duration, and wherein for each of the communication signal receiver branches, the moment sum is determined by summing |r_{j,i}| or |r_{j,i}|ⁿ for all the L time intervals, where n>=2.

In some embodiments, the STBC comprises an Alamouti code.

In some embodiments, the communication signals comprise symbols generated using any one of: a coherent modulation scheme, a non coherent modulation scheme and a differential modulation scheme.

In some embodiments, the communication signals comprise symbols generated using any one of: Binary Phase Shift Keying (BPSK) and MPSK.

In some embodiments, the selector is further configured to determine whether a difference in amplitudes of respective communication signals received through the selected communication signal receiver branch and another communication signal receiver branch of the plurality of communication signal receiver branches exceeds a threshold, and to select the another communication signal receiver branch where the difference exceeds the threshold.

In some embodiments, the subsequent communication signal processing comprises at least one of: space-time signal combining and signal detection.

In some embodiments, M=2 and N=1.

In some embodiments, N=2.

According to another broad aspect, the invention provides a communication device comprising: a plurality of antennas for receiving space-time block code STBC encoded diversity communication signals from a plurality of transmitter antennas; an apparatus operatively coupled to the plurality of antennas; and a communication signal processing path operatively coupled to the apparatus and configured to process the selected communication signals.

In some embodiments, the communication device comprises any one of a communication network base station and a mobile terminal.

Another broad aspect provides a communication system comprising a communication network comprising a network element; and a wireless communication device configured for communicating with the network element. At least one of the network element and the wireless communication device comprising the selector apparatus as summarized above.

In some embodiments, at least one of the network element and the wireless communication device comprises the plurality of transmitter antennas.

According to another broad aspect, the invention provides a communication signal receiver branch selection method comprising: for each of a plurality of receiver branches, determining a respective moment sum of signal plus noise samples of space-time diversity communication signals over a space-time block code length, each communication signal receiver branch being operatively coupled to a respective antenna for receiving communication signals from a plurality of transmitter antennas; selecting at least one communication signal receiver branch from the plurality of communication signal receiver branches having the largest moment sum; and providing communication signals from the selected communication signal receiver branch for subsequent communication signal processing.

In some embodiments, the method further comprises, after selecting: determining moment sums of communication signals received through the selected communication signal receiver branch and others of the plurality of communication signal receiver branches; determining whether a difference in moment sums of communication signals received through the selected communication signal receiver branch and another communication signal receiver branch of the plurality of communication signal receiver branches exceeds a threshold; and selecting the another communication signal receiver branch where the difference exceeds the threshold.

In another embodiment, a machine-readable medium storing instructions which when executed perform the method as summarized above.

Other aspects and features of the present invention will become apparent to those ordinarily skilled in the art upon review of the following description of specific illustrative embodiments thereof.

### BRIEF DESCRIPTION OF THE DRAWINGS

Examples of embodiments of the invention will now be described in greater detail with reference to the accompanying drawings, in which:

FIG. 1 is a block diagram illustrating a 2 by 2 MIMO system with an Alamouti transmission scheme;

FIG. 2 is a block diagram illustrating a 2 by 2 MIMO system having an MRC receiver;

FIG. 3 is a block diagram illustrating a 2 by 2 MIMO system having a conventional selection combining receiver;

FIG. 4 is a block diagram of a system in which an embodiment of the invention is implemented;

FIGS. 5-6 show plots of the average BER versus SNR per bit for different selection diversity schemes in a flat Rayleigh fading channel with perfect channel estimation and with channel estimation quality specified by cross-correlation 0.75, for a 2 by 2 system and a 2 by 4 system, respectively;

FIGS. 7-8 show plots of the average BER as a function of channel estimation quality ρ for various selection schemes with an SNR of 5 dB per bit for a 2 by 2 system and a 2 by 4 system, respectively;

FIG. 9 shows a plot of the average BER versus SNR from 0 dB to 10 dB for a 2 by 2 system when pilot symbol assisted modulation (PSAM) is used to estimate the channel gain;

FIG. 10 is a flow diagram illustrating a method according to an embodiment of the invention; and

FIG. 11 is a block diagram of a generalized combiner embodiment.

### DETAILED DESCRIPTION

Multiple-input multiple-output (MIMO) systems have attracted great interest since they can improve the capacity and reliability of wireless communication channels. The benefits of a MIMO system are discussed in G. Foschini and M. Gans, “On the limits of wireless communications in a fading environment when using multiple antennas,” Wireless Personal Commun., vol. 6, no. 3, pp. 311-335, March 1998, which is hereby incorporated by reference in its entirety. However, adopting a MIMO system increases the system complexity and the cost of implementation. A promising approach for reducing implementation complexity and power consumption, while retaining a reasonably good performance, is to employ some form of antenna selection.

In general, MIMO antenna selection combining (SC) includes receiver (Rx) antenna selection, transmitter (Tx) antenna selection and joint Tx/Rx selection. Both Tx/Rx selection and Tx selection require channel estimation to be fed back from the receiver to the transmitter. In order to avoid the need for a feedback channel, and to keep the system simple, some systems implement Rx selection diversity only. In MIMO Rx selection diversity, Lₛ out of L Rx antennas are selected while the Tx uses all available antennas. Some past work has examined MIMO Rx selection diversity. In A. Ghrayeb and T. M. Duman, “Performance analysis of MIMO systems with antenna selection over quasistatic fading channels,” IEEE Trans. Veh. Technol., vol. 52, no. 2, pp. 281-288, March 2003; I. Bahceci, T. M. Duman, and Y. Altunbasak, “Antenna selection for multiple-antenna transmission systems: performance analysis and code construction,” IEEE Trans. Inform. Theory, vol. 49, no. 10, pp. 2669-2681, October 2003; and X. Zeng and A. Ghrayeb, “Performance bounds for space-time block codes with receive antenna selection,” IEEE Trans. Inform. Theory, vol. 50, no. 9, pp. 2130-2137, September 2004; which are hereby incorporated by reference in their entireties, the Rx selection criteria are chosen in the sense of achieving the maximum received signal-to-noise ratio (SNR). An approximation of pairwise error probability is given in the above-identified A. Ghrayeb and T. M. Duman reference. An upper bound on pairwise error probability is presented in the above-identified I. Bahceci, T. M. Duman, and Y. Altunbasak reference. In the above-identified X. Zeng and A. Ghrayeb reference, an upper bound on bit error rate (BER) is derived.

The effects of channel estimation error on the BER performance of a MIMO system using binary phase-shift keying (BPSK) modulation and receiver selection diversity in a slow flat Rayleigh fading channel is examined analytically below. As an illustrative example, the case of an Alamouti space-time block code (STBC), as described in S. M. Alamouti, “A simple transmit diversity technique for wireless communications,” IEEE J. Select. Areas Commun., vol. 16, no. 8, pp. 1451-1458, October 1998, which is hereby incorporated by reference in its entirety, at a transmitter is considered in detail. The “best” of L Rx antennas is chosen according to some selection criterion. Since all currently used selection combining schemes require some knowledge of the complex channel gains for all or some of the diversity branches, and thus the complex channel gains have to be estimated at the receiver, channel estimation errors affect the performance of all current practical selection combining schemes.

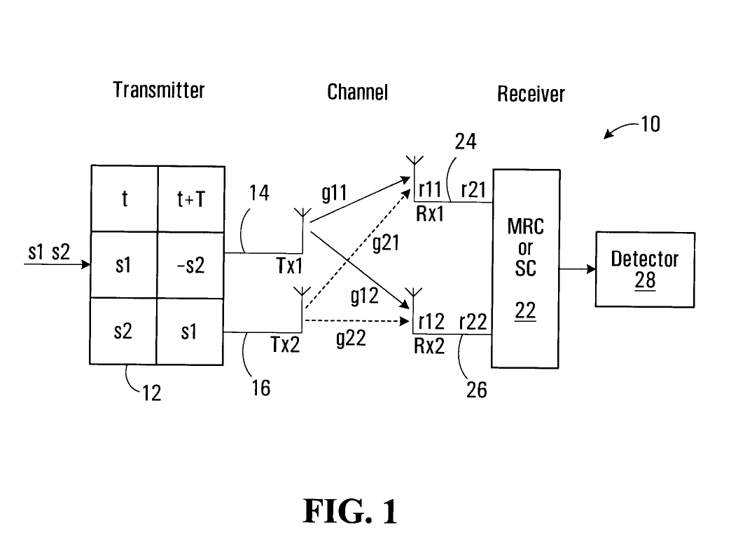

The Alamouti scheme is a transmission scheme that defines how to transmit data symbols from two transmitter antennas. FIG. 1 is a block diagram illustrating a 2 by 2 MIMO system with an Alamouti transmission scheme.

In the system 10, an encoder at the transmitter is represented at 12, and is operatively coupled to two antennas 14, 16. At the receiver, an MRC or SC decoder 22 is operatively coupled to two receive antennas 24, 26, and to a detector 28.

The channel over which communication signals are transmitted from the transmitter to the receiver in the system 10 may be established, for example, through a wireless communication network. Although a certain type of channel and transmission encoding scheme are considered in detail herein, it should be appreciated that the invention is in no way limited to any particular type of channel or encoding. The examples provided herein are intended solely for illustrative purposes, and not to limit the scope of the invention.

In an Alamouti transmission scheme, two data symbols, s₁ and s₂, are transmitted at two time intervals through the two transmitter antennas 14, 16. More specifically, with binary phase shift keying (BPSK) modulation, at time interval t, data symbol s₁ is transmitted from antenna Tx1 14 and data symbol s₂ is transmitted from antenna Tx2 16, and at the next time interval t+T, −s₂ is transmitted from antenna Tx1 14 and s₁ is transmitted from antenna Tx2 16. Thus, these two data symbols are transmitted separately at different spaces and different times to provide space-time diversity.

At the receiver (Rx) side, the Rx antenna Rx1 24 receives symbol r₁₁ at the first time interval and r₂₁ at the second time interval, and the Rx antenna Rx2 26 receives r₁₂ at the first time interval and r₂₂ at the second time interval, where r₁₁, r₂₁, r₁₂, and r₂₂ represent signal combinations of s₁ and s₂ corrupted by the wireless channel.

Since wireless channels are time-variant, the channel gains g₁₁, g₁₂, g₂₁, and g₂₂ in FIG. 1 are randomly varying with time and need to be estimated at the receiver for signal detection.

Having generally described the Alamouti transmission scheme, different known selection schemes and selection schemes according to embodiments of the invention will be considered in further detail.

The first scheme described below is log-likelihood ratio (LLR) selection, which was proposed in Sang Wu Kim and Eun Yong Kim, “Optimum selection diversity for BPSK signals in Rayleigh fading channels,” IEEE Trans. Commun., vol. 49, no. 10, pp. 1715-1718, October 2001, which is hereby incorporated by reference in its entirety, for one Tx antenna and L Rx antennas system. In LLR selection, full knowledge of all the complex diversity branch gains is needed and the branch providing the largest magnitude of LLR is chosen. This selection scheme was extended in Sang Wu Kim and Eun Yong Kim, “Optimum receive antenna selection minimizing error probability,” in Proc. Wireless Communications and Networking Conference, March 2003, vol. 1, pp. 441-447, which is hereby incorporated by reference in its entirety, to include a 2 Tx antennas and N_{R} Rx antennas system using the Alamouti scheme. The BER for this scheme is given below by an expression involving a single integral. However, perfect channel estimation is assumed in the scheme described in this reference. A closed-formed BER expression for this LLR selection scheme is provided below, accounting for the presence of channel estimation errors.

Traditional selection combining is the second scheme considered below. The selection of the best antenna is based on the largest SNR among the diversity branches at the detector input. Unlike LLR selection which requires full knowledge of the complex channel gains for all the diversity branches, SNR selection only requires ordering fading amplitudes on the diversity branches. In D. Gore and A. Paulraj, “Space-time block coding with optimal antenna selection,” in Proc. IEEE Int. Conf. on Acoustics, Speech, and Signal Processing, May 2001, vol. 4, pp. 2441-2444, which is hereby incorporated by reference in its entirety, SNR selection is applied to the transmitter selection. Two Tx antennas which provide the largest and the second largest SNR are used for transmitting an STBC. The performance of the system is assessed in terms of an outage capacity analysis but exact BER results are not given. In the above-identified X. Zeng and A. Ghrayeb reference and in the above-identified reference by Sang Wu Kim and Eun Yong Kim entitled “Optimum receive antenna selection minimizing error probability,”, the BER of SNR selection at the receiver side is evaluated. This result is extended herein to include the effects of channel estimation errors.

Since both LLR selection and SNR selection schemes require channel knowledge for antenna selection, a new selection scheme according to an embodiment of the invention is proposed. This scheme is referred to herein primarily as Space-Time Sum-of-Squares (STSoS) selection. The STSoS selection scheme does not require knowledge of the channel gains to make the Rx antenna selection. Furthermore, branch selection is done before the space-time decoding so that channel estimation for the space-time decoding is only performed for the branch selected, achieving a significant complexity reduction. Compared to the two former schemes, this new scheme is much simpler to implement, and provides essentially the same performance as the SNR selection scheme.

In one embodiment, the proposed STSoS selection combining involves squaring the amplitudes of received signals before making an antenna selection. In order to further simplify the hardware implementation, another scheme which processes only the amplitudes of the received signals is also proposed. Similar to STSoS selection, this scheme, referred to herein as Space-Time Sum-of-Magnitudes (STSoM) selection, does not require channel estimation. Simulation results provided below show that STSoM selection has only slightly poorer BER performance than STSoS and SNR selection.

In order to implement SNR selection combining, a receiver must monitor all diversity branches to select the “best” branch. The receiver may also switch frequently in order to use the best branches. It is desirable in some practical implementations to minimize switching in order to reduce switching transients. It is also desirable to monitor only one branch rather than all branches. Therefore, selection combining is often implemented in the form of switched diversity in practical systems, rather than continuously picking the best branch, the receiver selects a particular branch and monitors this branch until its quality drops below a predetermined threshold. See, for example, the switched diversity described in W. C. Jakes, Microwave Mobile Communications, IEEE Press, Piscataway, N.J., 1993 and in W. Lee, Mobile Communications Engineering, McGraw-Hill, New York, 1982, which are hereby incorporated by reference in their entireties. When this happens, the receiver switches to another branch. M. A. Blanco and K. J. Zdunek, “Performance and optimization of switched diversity systems for the detection of signals with Rayleigh fading,” IEEE Trans. Commun., vol. 27, pp. 1887-1895, December 1979 and A. A. Abu-Dayya and N. C. Beaulieu, “Analysis of switched diversity systems on generalized-fading channels,” IEEE Trans. Commun., vol. 42, no. 11, pp. 2959-2966, November 1994, which are hereby incorporated by reference in their entireties, investigate a switched diversity system with one Tx antenna and N_{R}, Rx antennas. A performance analysis for this system without space-time coding was given in Rayleigh fading and in Nakagami fading in these references respectively.

In H. Yang and M. Alouini, “Performance analysis of multibranch switched diversity systems,” IEEE Trans. Commun., vol. 51, no. 5, pp. 782-794, May 2003, which is hereby incorporated by reference in its entirety, switched diversity is applied at the transmitter side and the cumulative distribution function (cdf), the probability density function (pdf), and the moment-generating function (MGF) of the received signal power are derived, again without space-time coding.

The present application presents an analysis of a transmission system with an Alamouti code at the Tx and switched diversity at the Rx. The average BER accounting for the effects of channel estimation error is derived and the optimal switching threshold that minimizes the BER for this switched diversity scheme is determined.

In general, we consider a system where an Alamouti scheme, such as the one described in the above-identified S. M. Alamouti reference, is applied with two Tx antennas and L Rx antennas. FIG. 1 shows a space-time block code system for the special case of two Rx antennas for illustration. For a BPSK modulation, the transmitted signal can be either +1 or −1. As described above, signals s₁ and s₂, corresponding to two information bits for instance, are sent simultaneously during two consecutive time intervals. Single bit symbols are discussed solely for illustrative purposes. The present invention may be applied to symbols of one or more bits.

The corresponding received signals in these two intervals on the ith receiver branch can be expressed in equivalent baseband form as

r_{1,i}=g_{1,i}s₁+g_{2,i}s₂+n_{1,i} (1a)

r_{2,i}=−g_{1,i}s₂+g_{2,i}s₁+n_{2,i} (1b)

where g_{j,i}, j=1, 2, i=1, . . . , L is the complex gain between the jth Tx antenna and the ith Rx antenna, and n_{j,i}, j=1, 2, i=1, . . . , L represents additive channel noise. The variances of the real (or imaginary) components of g_{j,i} and n_{j,i} are denoted by σ_{g}² and σₙ², respectively. The average SNR of the received signal is defined here as γ̅=2σ_{g}²/σₙ². The maximum likelihood (ML) decoding of s₁ and s₂ by the detector 28 (FIG. 1) is based on the outputs of ST combiners, such as those described in the above-identified S. M. Alamouti reference, in the decoder 22

y_{1,i}=ĝ*_{1,i}r_{1,i}+ĝ_{2,i}r*_{2,i} (2a)

y_{2,i}=ĝ*_{2,i}r_{1,i}−ĝ_{1,i}r*_{2,i} (2b)

where ĝ_{j,i} is the estimate of g_{j,i} with variance σ_{ĝ}², in the real and imaginary part. The signal estimate is ŝ₁=sgn(Re(y_{j,i})), j=1, 2, where sgn(x)=signum(x) is defined at p. xlv of I. S. Gradshteyn and I. M. Ryzhik, Table of Integral, Series, and Products, Academic Press, 6th edition, 2000, which is hereby incorporated by reference in its entirety.

The complex channel gains g_{j,i} are estimated at the receiver prior to fading compensation. We assume identical statistics for the independent diversity branches, and that the correlation between g_{j,i} and its estimate ĝ_{j,i} is the same on each branch. Extending the results in Michael J. Gans, “The effect of Gaussian error in maximal ratio combiners,” IEEE Trans. Commun. Technol., vol. 19, no. 4, pp. 492-500, August 1971, which is hereby incorporated by reference in its entirety, to include the case when the variances of the channel gain and its estimate are unequal, we define

$${g}_{j , i} = ( \frac{{R}_{c}}{{σ}_{\hat{g}}^{2}} + j \frac{{R}_{cs}}{{σ}_{\hat{g}}^{2}} ) {\hat{g}}_{j , i} + ( {x}_{j , i} + j {y}_{j , i} ) \qquad ( 3 )$$

where x_{j,i} and y_{j,i} are uncorrelated with ĝ_{j,i}. The parameters R_{c} and R_{cs} are given by

R_{c}=E[g₁ĝ₁]=E[g_{Q}ĝ_{Q}] (4a)

R_{cs}=E[g₁ĝ_{Q}]=−E[g_{Q}ĝ₁]. (4b)

Under the Rayleigh fading assumption described in G. L. Stüber, Principles of Mobile Communication, Norwell, Mass.: Kluwer, 2nd edition, 2001, which is hereby incorporated by reference in its entirety, R_{cs}=0, and we can simplify (3) to

g_{j,i}=kĝ_{j,i}+d_{j,i} (5)

where k=R_{C}/σ_{g}² and d_{j,i}=(x_{j,i}+jy_{j,i}). As described in L. Cao and N. C. Beaulieu, “Exact error-rate analysis of diversity 16-QAM with channel estimation error,” IEEE Trans. Commun., vol. 52, no. 6, pp. 1019-1029, June 2004, which is hereby incorporated by reference in its entirety, the variance of the real (or imaginary) component of d_{j,i} is σ_{d}²=(1−ρ)σ_{g}², where ρ is the squared amplitude of the cross-correlation coefficient of the channel fading and its estimate

$$ρ = \frac{{E}^{2} [ g {\hat{g}}^{*} ]}{E [ {\vert g \vert}^{2} ] E [ {\vert \hat{g} \vert}^{2} ]} = \frac{{R}_{c}^{2}}{{σ}_{g}^{2} {σ}_{\hat{g}}^{2}} = \frac{{σ}_{\hat{g}}^{2}}{{σ}_{g}^{2}} {k}^{2} . \qquad ( 6 )$$

When pilot symbol assisted modulation (PSAM) is employed to estimate the fading channel gain, the cross-correlation coefficient of the channel fading and its estimate can be expressed as

$$ρ = \frac{{[ {\sum }_{k = - ⌊ \frac{K - 1}{2} ⌋}^{⌊ \frac{K}{2} ⌋} {h}_{k}^{n} {J}_{0} ( 2 π {f}_{D} \vert kN - 2 n \vert {T}_{s} ) ]}^{2}}{{\sum }_{k = - ⌊ \frac{K - 1}{2} ⌋}^{⌊ \frac{K}{2} ⌋} {\sum }_{m = - ⌊ \frac{K - 1}{2} ⌋}^{⌊ \frac{K}{2} ⌋} {h}_{k}^{n} {h}_{m}^{n} {J}_{0} ( 2 π {f}_{D} \vert k - m \vert {NT}_{s} ) + \frac{1}{\overline{γ}} {\sum }_{m = - ⌊ \frac{K - 1}{2} ⌋}^{⌊ \frac{K}{2} ⌋} {( {h}_{k}^{n} )}^{2}} \qquad ( 7 )$$

where K is the size of the interpolator, hₖⁿ and hₘⁿ are the interpolator coefficients, f_{D} is the Doppler shift, Tₛ is the symbol interval, N is the frame size and J₀(•) is the zeroth-order Bessel function of the first kind. The detailed derivation of ρ is included below in Appendix A.

By symmetry, the BER is the same for s₁ and s₂, so the following analysis will consider s₁ only. The results for sᵢ, i=1, 2 can be obtained by appropriately renaming the variables.

Using (1), (2a) and (5), the combiner output y_{1,i} can be written as

y_{1,i}=k(|ĝ_{1,i}|²+|ĝ_{2,i}|²)s₁+(ĝ*_{1,i}d_{1,i}+ĝ_{2,i}d*_{2,i})s₁+(ĝ*_{1,i}d_{2,i}−ĝ_{2,i}d*_{1,i})s₂+ĝ*_{1,i}n_{1,i}+ĝ_{2,i}n*_{2,i}. (8)

Since s₂=+s₁ or −s₁, each with probability ½, we can calculate the BER as P_{b=}½(P_{b,s}_{₂}₌ₛ_{₁}+P_{b,s}_{₂}₌₋ₛ_{₁})=P_{b,s}_{₂}ₛ_{₁}=P_{b,s}_{₂}₌ₛ_{₁}₌₁, where the last two equations follow from symmetry. For the case s₂=s₁=1, from (8) we can write the decision variable for y_{1,i} as

Re(y_{1,i})=k(|ĝ_{1,i}|²+|ĝ_{2,i}|²)+Re[ĝ*_{1,i}(d_{1,i}+d_{2,i})+ĝ_{2,i}(d_{2,i}−d_{1,i})*]+Re(ĝ*_{1,i}n_{1,i})+Re(ĝ_{2,i}n*_{2,i}). (9)

Conditioning on |ĝ_{1,i}|² and |ĝ_{2,i}|², it can be shown that Re[ĝ*_{1,i}(d_{1,i}+d_{2,i})], Re[ĝ*_{2,i}(d_{2,i}−d_{1,i})], Re(ĝ*_{1,i}n_{1,i}) and Re(ĝ_{2,i}n*_{2,i}) are independent, zero-mean Gaussian random variables with variance 2|ĝ_{1,i}|²σ_{d}², 2|ĝ_{2,i}|²σ_{d}², |ĝ_{1,i}|²σₙ² and |ĝ_{2,i}|²σₙ², respectively. Therefore, Re(y_{1,i}), conditioned on |ĝ_{1,i}|² and |ĝ_{2,i}|², is a Gaussian random variable as well. It has mean k(|ĝ_{1,i}|²+|ĝ_{2,i}|²) and variance (2σ_{d}²+σₙ²)(|ĝ_{1,i}|²+|ĝ_{2,i}|²).

To simplify the following BER calculation, we normalize the expression in (9) by dividing both sides of the equation with 2kσ_{ĝ}². Then (9) can be written as

$$\begin{matrix}Re ( {y}_{1 , i}^{′} ) = \frac{Re ( {y}_{1 , i} )}{2 k {σ}_{\hat{g}}^{2}} \\ = \frac{1}{2 {σ}_{\hat{g}}^{2}} ( {\vert {\hat{g}}_{1 , i} \vert}^{2} + {\vert {\hat{g}}_{2 , i} \vert}^{2} ) + \\ \frac{1}{2 k {σ}_{\hat{g}}^{2}} \{ Re [ {\hat{g}}_{1 , i}^{*} ( {d}_{1 , i} + {d}_{2 , i} ) + {{\hat{g}}_{2 , i} ( {d}_{2 , i} - {d}_{1 , i} )}^{*} ] + \\ Re ( {\hat{g}}_{1 , i}^{*} {n}_{1 , i} ) + Re ( {\hat{g}}_{2 , i} {n}_{2 , i}^{*} ) \} .\end{matrix} \qquad ( 10 )$$

Let

$${a}_{i} = \frac{{\vert {\hat{g}}_{1 , i} \vert}^{2} + {\vert {\hat{g}}_{2 , i} \vert}^{2}}{2 {σ}_{\hat{g}}^{2}} .$$

Conditioned on aᵢ, the new decision variable Re(y′_{1,i}) has mean aᵢ and variance

$$\frac{( 2 {σ}_{d}^{2} + {σ}_{n}^{2} )}{2 {k}^{2} {σ}_{\hat{g}}^{2}} {a}_{i} .$$

Using (6) and σ_{d}²=(1−ρ)σ_{g}², this variance is simplified to

$$\frac{( 1 - ρ ) \overline{γ} + 1}{ρ \overline{γ}} {a}_{i} .$$

Define the effective SNR

$${\overline{γ}}_{c} = \frac{ρ \overline{γ}}{( 1 - ρ ) \overline{γ} + 1} . \qquad ( 11 )$$

Then the variance is

$$\frac{{a}_{i}}{{\overline{γ}}_{c}} .$$

Since ĝ_{1,i} and ĝ_{2,i} are independent, zero-mean complex Gaussian random variables, aᵢ has a chi-square distribution with 4 degrees of freedom and according to J. G. Proakis, Digital Communications, McGraw-Hill, 1995, which is hereby incorporated by reference in its entirety, its pdf is given by

f_{A}(aᵢ)=aᵢexp(−aᵢ) (12)

The BER calculation is based on the conditioned probability of Re(y′_{1,i})<0. That is,

$${P}_{b} = {\sum }_{i = 1}^{L} Pr ( Re ( {y}_{1 , i}^{′} ) < 0 ,$$

ith branch selected).

### LLR Selection Combining

An LLR Rx selection system model is described in the above-identified reference by Sang Wu Kim and Eun Yong Kim entitled “Optimum receive antenna selection minimizing error probability,”. With the Alamouti scheme and imperfect channel estimation, the log-likelihood ratio for data symbol s₁, given ĝ_{j,i}, j=1, 2 and y_{1,i} is

$$\begin{matrix}{Λ}_{i} = ln \frac{P ( {s}_{1} = + 1 \vert {\hat{g}}_{j , i} , {y}_{1 , i} )}{P ( {s}_{1} - 1 \vert {\hat{g}}_{j , i} , {y}_{1 , i} )} \\ = ln \frac{p ( {y}_{1 , i} \vert {\hat{g}}_{j , i} , {s}_{1} = + 1 )}{p ( {y}_{1 , i} \vert {\hat{g}}_{j , i} , {s}_{1} = - 1 )} .\end{matrix} \qquad ( 13 )$$

From (8), conditioning on ĝ_{j,i}, it can be shown that y_{1,i} is a complex Gaussian random variable with mean k(|ĝ_{1,i}|²+|ĝ_{2,i}|²)s₁=m_{y}s₁ and real/imaginary part variance σ_{y}²=(2σ_{d}²+σₙ²)(|ĝ_{1,i}|²+|ĝ_{2,i}|²). Then continuing (13), we have

$$\begin{matrix}{Λ}_{i} = ln \frac{exp [ - {\vert {y}_{1 , i} - {m}_{y} \vert}^{2} / ( 2 {σ}_{y}^{2} ) ]}{exp [ - {\vert {y}_{1 , i} + {m}_{y} \vert}^{2} / ( 2 {σ}_{y}^{2} ) ]} \\ = \frac{2 {m}_{y}}{{σ}_{y}^{2}} Re ( {y}_{1 , i} ) \\ = \frac{2 k}{( 2 {σ}_{d}^{2} + {σ}_{n}^{2} )} Re ( {y}_{1 , i} ) \\ = \frac{2 {R}_{c}}{( 2 {σ}_{d}^{2} + {σ}_{n}^{2} ) {σ}_{\hat{g}}^{2}} Re ( {y}_{1 , i} ) .\end{matrix} \qquad ( 14 )$$

Since R_{c}, σ_{d}², σₙ², and σ_{ĝ}² are the same across all the receiver branches, the LLR Rx selection combining is equivalent to selecting the branch providing the largest amplitude of Re(y_{1,i}). Note that with perfect channel estimation, i.e., when R_{c}=σ_{ĝ}²=σ_{g}² and σ_{d}²=0, Λᵢ=4/N₀Re(y_{1,i}), which matches the result in eq. (37) of the above-identified reference by Sang Wu Kim and Eun Yong Kim entitled “Optimum receive antenna selection minimizing error probability,”, where N₀ is the noise power spectral density.

The final expression for the BER for LLR selection combining is derived in Appendix B. It is

$${P}_{b} = L {\sum }_{n = 0}^{L - 1} {\sum }_{m = 0}^{L - 1 - n} {\sum }_{p = 0}^{n} {\sum }_{q = 0}^{m} {\sum }_{i = 0}^{1} ( \begin{matrix}L - 1 \\ n\end{matrix} ) ( \begin{matrix}L - 1 - n \\ m\end{matrix} ) ( \begin{matrix}n \\ p\end{matrix} ) ( \begin{matrix}m \\ q\end{matrix} ) \qquad ( 15 )$$

$$\times {AB}^{i} {m}_{1}^{n - p} {m}_{2}^{p} {m}_{4}^{m - q} {m}_{5}^{q} {m}_{7}^{L - 1 - n - m} \frac{{( - 1 )}^{m + p} ( p + q + i ) !}{{( {m}_{3} n + {m}_{6} m + B + C )}^{p + q + i + 1}}$$

where A-C, m₁-m₇ are given in (39b) and (40b), respectively.

A simpler sub-optimum selection combining rule was also proposed in the above-identified reference by Sang Wu Kim and Eun Yong Kim entitled “Optimum selection diversity for BPSK signals in Rayleigh fading channels,”. Instead of the amplitude of Re(y_{1,i}), |(y_{1,i})| is used for this envelope-LLR selection combining. Simulation results for the BER of this envelope-LLR selection scheme will be given together with results for the other selection combining schemes below.

### MRC Diversity

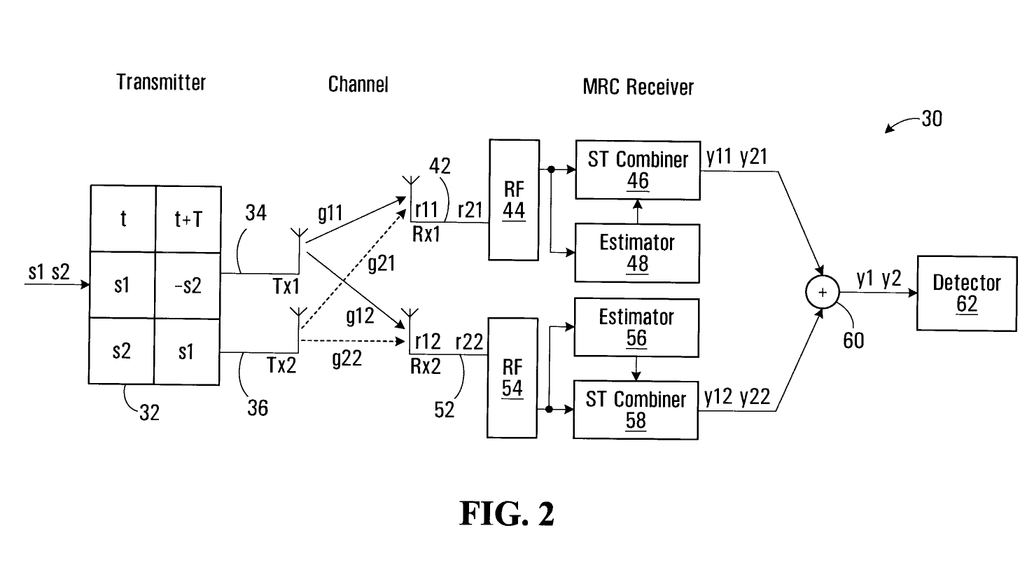

FIG. 2 is a block diagram illustrating a 2 by 2 MIMO system having an MRC receiver. The transmitter side of the system 30 may be the same as the transmitter side of the system 10 (FIG. 1), and includes an encoder 32 and transmit antennas Tx1 34, Tx2 36. The channel portion of the system 30 may also be the same as that of the system 10. FIG. 2 shows details of an MRC receiver.

The conventional MRC receiver for an Alamouti scheme, as shown in FIG. 2, is implemented with two receiver antennas Rx1 42, Rx2 52 for illustration. In a receiver using MRC, the receiver needs L space-time (ST) combiners 46, 58 to combine received signals. The purpose of the ST combiners 46, 58 is to process signals received through the antennas Rx1 42, Rx2 52 and corresponding RF circuitry 44, 54, and make them ready for detection by the detector 62. Basically, the ST combiners 46, 58 get channel information from the channel estimators 48, 56, then use these estimated channel gains to weight r₁₁, r₂₁, r₁₂, r₂₂ to obtain y₁₁, y₂₁, y₁₂, y₂₂. After the ST combiners 46, 58, generated signals y₁₁ and y₂₁ are added together in the adder 60 to get y₁. Similarly, y₁₂ and y₂₂ are added together to get y₂. Finally, the detector 62 extracts the sign of the real part of y₁ and y₂ and uses it to decide the symbols s₁ and s₂, respectively. If positive, a +1 symbol is decided. Otherwise, a −1 symbol is decided.

In MRC, all combiner outputs are weighted and summed to form the decision variable as illustrated in FIG. 1 of the above-identified S. M. Alamouti reference. From (10), the output of each combiner 46, 58 is

$$Re [ {\sum }_{i = 1}^{L} {y}_{1 , i}^{′} ] = \frac{1}{2 {σ}_{\hat{g}}^{2}} {\sum }_{i = 1}^{L} ( {\vert {\hat{g}}_{1 i} \vert}^{2} + {\vert {\hat{g}}_{2 i} \vert}^{2} ) + \frac{1}{2 k {σ}_{\hat{g}}^{2}} Re {\sum }_{i = 1}^{L} [ {\hat{g}}_{1 , i}^{*} ( {d}_{1 , i} + {d}_{2 , i} ) + {{\hat{g}}_{2 , i} ( {d}_{2 , i} - {d}_{1 , i} )}^{*} + ( {\hat{g}}_{1 , i}^{*} {n}_{1 , i} ) + ( {\hat{g}}_{2 , i} {n}_{2 , i}^{*} ) ] . \qquad ( 16 )$$

Conditioned on

$$y = \frac{{\sum }_{i = 1}^{L} ( {\vert {\hat{g}}_{1 i} \vert}^{2} + {\vert {\hat{g}}_{2 i} \vert}^{2} )}{2 {σ}_{\hat{g}}^{2}} ,$$

this decision variable is a Gaussian random variable with mean y and variance

$$\frac{y}{{\overline{γ}}_{c}} .$$

As discussed in the above-identified J. G. Proakis reference, the pdf of y is chi-square distributed with 4 L degrees of freedom

$${f}_{Y} ( y ) = \frac{1}{( 2 L - 1 ) !} {y}^{2 L - 1} exp ( - y ) . \qquad ( 17 )$$

Following the above-identified J. G. Proakis reference, the BER for MRC with Alamouti coding is obtained as

$$\begin{matrix}\begin{matrix}{P}_{b} = {\int }_{0}^{∞} Q ( \sqrt{{\overline{γ}}_{c} y} ) {f}_{Y} ( y ) d y \\ = {[ \frac{1}{2} ( 1 - {μ}_{2} ) ]}^{2 L} {\sum }_{k = 0}^{2 L - 1} {( \begin{matrix}2 L - 1 + k \\ k\end{matrix} ) [ \frac{1}{2} ( 1 + {μ}_{2} ) ]}^{k}\end{matrix} & ( 18 a ) \\ {μ}_{2} = \sqrt{\frac{{\overline{γ}}_{c}}{{\overline{γ}}_{c} + 2}} . & ( 18 b )\end{matrix}$$

### SNR Selection Combining

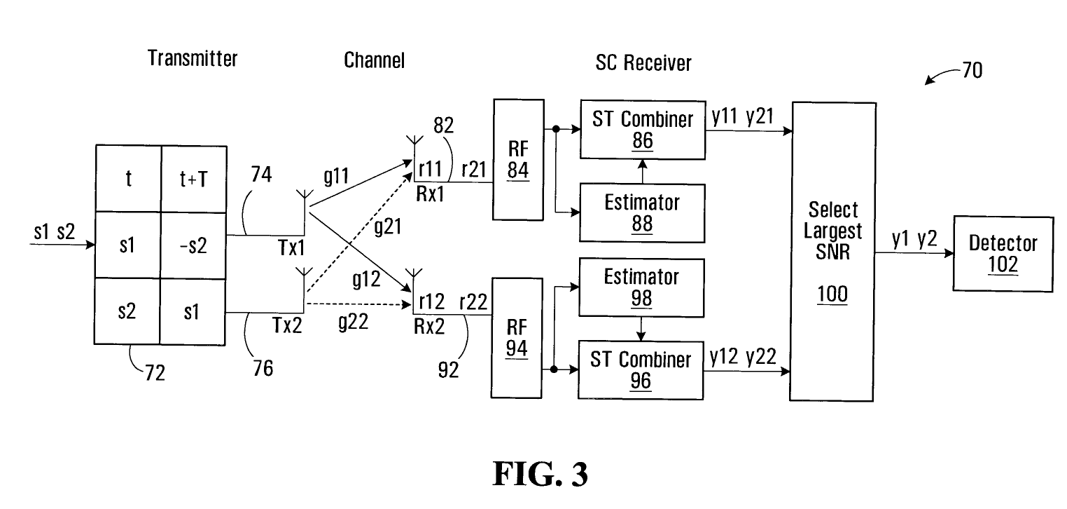

A 2 by 2 MIMO system having a conventional selection combining receiver is shown in FIG. 3. As noted above for FIG. 2, the transmitter and channel portions of the system 70 may be the same as those of the system 10 (FIG. 1). The transmitter of the system 70 includes an encoder 72 and transmit antennas Tx1 74, Tx2 76.

The SC receiver has the same structure as the MRC receiver of FIG. 2 with respect to the receive antennas RX1 82, Rx2 92, RF circuitry 84, 94, ST combiners 86, 96, and estimators 88, 98. The difference is that the SC receiver includes a selection module 100 which selects only one receiver branch for final signal detection by the detector 102. In order to implement the selection, the receiver needs additional circuitry, represented at 100, to calculate the SNR of y₁ᵢ and y₂ᵢ, i=1, 2, and then select the branch with the largest SNR. The combiner output signals y₁ᵢ and y₂ᵢ from only that branch are sent to the detector 102. Thus, in contrast to MRC, when only one branch is selected, the other branches can be shut down to reduce total power consumption.

The Rx selection combining scheme model is the same as the model described in both the above-identified X. Zeng and A. Ghrayeb reference and the above-identified reference by Sang Wu Kim and Eun Yong Kim entitled “Optimum receive antenna selection minimizing error probability,”. In SNR selection combining, the Rx antenna with the largest SNR will be chosen for space-time decoding. From (8), the SNR, given the ith Rx antenna selected, is

$$\frac{{k}^{2} ( {\vert {\hat{g}}_{1 , i} \vert}^{2} + {\vert {\hat{g}}_{2 , i} \vert}^{2} )}{2 ( 2 {σ}_{d}^{2} + {σ}_{n}^{2} )} = \frac{{\overline{γ}}_{c} {a}_{i}}{2} .$$

Therefore, the antenna providing the largest SNR is the one providing the largest aᵢ. Let

$${A}_{max} = max [ \frac{{\vert {\hat{g}}_{1 , i} \vert}^{2} + {\vert {\hat{g}}_{2 , i} \vert}^{2}}{2 {σ}_{\hat{g}}^{2}} ] .$$

Then, as described in the above-identified reference by Sang Wu Kim and Eun Yong Kim entitled “Optimum receive antenna selection minimizing error probability,”, the expression of the bit error rate can be rewritten as

P_{b}=L·∫₀^{∞}Pr(Re(y_{1,i})≦0|Aₘₐₓ=a)f_{A}_{ₘₐₓ}(a)da=∫₀^{∞}Q(\sqrt{γ̅_{c}a})f_{A}_{ₘₐₓ}(a)da (19a)

where, as described in H. A. David, Order Statistics, Wiley, New York, 1981, which is hereby incorporated by reference in its entirety, the pdf of Aₘₐₓ is

f_{A}_{ₘₐₓ}(a)=L[∫₀^{a}f_{A}(aᵢ)daᵢ]^{L-1}f_{A}(a)=L[1−(1+a)exp(−a)]^{L-1}f_{A}(a) (19b)

and f_{A}(a) is given in (12).

Expanding [∫₀^{a}f_{A}(a)da]^{L-1} in (19b) using the binomial theorem gives

$${P}_{b} = L \times {\sum }_{i = 0}^{L - 1} {\sum }_{j = 0}^{i} ( \begin{matrix}L - 1 \\ i\end{matrix} ) ( \begin{matrix}i \\ j\end{matrix} ) {( - 1 )}^{i} {\int }_{0}^{∞} Q ( \sqrt{{\overline{γ}}_{c} a} ) {a}^{j + 1} exp [ - ( i + 1 ) a ] d a . \qquad ( 20 )$$

Integrating (20) term-by-term, the final expression for the BER is derived as

$$\begin{matrix}{P}_{b} = L \times {\sum }_{i = 0}^{L - 1} {\sum }_{j = 0}^{i} {\sum }_{m = 0}^{j + 1} {( - 1 )}^{i} ( \begin{matrix}L - 1 \\ i\end{matrix} ) ( \begin{matrix}i \\ j\end{matrix} ) \frac{( j + 1 + m ) !}{m ! {( 1 + i )}^{j + 2}} {( \frac{1 - {μ}_{1}}{2} )}^{j + 2} {( \frac{1 + {μ}_{1}}{2} )}^{m} & ( 21 a ) \\ {μ}_{1} = \sqrt{\frac{{\overline{γ}}_{c}}{{\overline{γ}}_{c} + 2 i + 2}} . & ( 21 b )\end{matrix}$$

Embodiments of the invention as disclosed herein have the same performance as SC but with much simpler implementation and reduced power consumption.

### Switch-and-Stay Selection

Switch-and-stay selection combining (SSC), which is described in the above-identified M. A. Blanco and K. J. Zdunek reference, functions in the following manner: assuming antenna 1 is being used, one switches to antenna 2 only if the instantaneous signal power in antenna 1 falls below a certain threshold, γₜₕ, regardless of the value of the instantaneous signal power in antenna 2. The switching from antenna 2 to antenna 1 is performed in the same manner. The major advantage of this strategy is that only one envelope signal need be examined at any instant. Therefore, it is much simpler to implement than traditional selection combining because it is not necessary to keep track of the signals from both antennas simultaneously. However, the performance of SSC is poorer than the performance of selection combining. Using the Alamouti scheme at the Tx antenna side, and assuming the fadings on the Rx antenna branches are independently, identically Rayleigh distributed, as described in the above-identified H. Yang and M. Alouini reference, the number of branches at the Rx side does not, if greater than one, affect the average BER performance. As a result, two Rx antennas are assumed here.

In Rx SSC, with channel estimation error, the BER is related to the instantaneous effective SNR of the selected ith branch γ_{c} in (8), where

$${γ}_{c} = \frac{{k}^{2} ( {\vert {\hat{g}}_{1 , i} \vert}^{2} + {\vert {\hat{g}}_{2 , i} \vert}^{2} )}{2 ( 2 {σ}_{d}^{2} + {σ}_{n}^{2} )} .$$

Conditioning on the pdf of γ_{c}, the BER is Q(\sqrt{2γ_{c}}). The final BER expression is derived in Appendix C. It is

$${P}_{b} = {K}_{1} - [ \begin{matrix}{K}_{1} ( \frac{2 {γ}_{th}}{{\overline{γ}}_{c}} + 1 ) - \\ \frac{2 {γ}_{th} + {\overline{γ}}_{c}}{{\overline{γ}}_{c}} Q ( \sqrt{2 {γ}_{th}} ) + \\ \frac{\sqrt{{γ}_{th}}}{\sqrt{π} ( {\overline{γ}}_{c} + 2 )} exp ( - {γ}_{th} )\end{matrix} ] exp ( - \frac{2 {γ}_{th}}{{\overline{γ}}_{c}} ) - {K}_{2} Q ( \sqrt{\frac{2 {γ}_{th} ( {\overline{γ}}_{c} + 2 )}{{\overline{γ}}_{c}}} ) \qquad ( 22 )$$

where K₁ and K₂ are given in (45b) and (45c), respectively.

Note that the BER depends on the value of the switching threshold, γₜₕ. The optimal value, γ*ₜₕ, is a solution of the equation

$$\frac{\partial {P}_{e}}{\partial {γ}_{th}} {\vert}_{{γ}_{th} = {γ}_{th}^{*}} = 0.$$

Differentiating (22) with respect to γₜₕ, we get

$${γ}_{th}^{*} = {\frac{1}{2} [ {Q}^{- 1} ( α ) ]}^{2} , \\ α = \frac{1}{2} - \frac{{\overline{γ}}_{c} \sqrt{{\overline{γ}}_{c}}}{2 \sqrt{{( {\overline{γ}}_{c} + 2 )}^{3}}} - \frac{3 \sqrt{{\overline{γ}}_{c}}}{2 \sqrt{{( {\overline{γ}}_{c} + 2 )}^{3}}} \qquad ( 23 )$$

where Q⁻¹(•) denotes the inverse Gaussian Q-function, and γ̅_{c} is the effective SNR (11).

### Space-Time Sum-of-Squares (STSoS) Selection

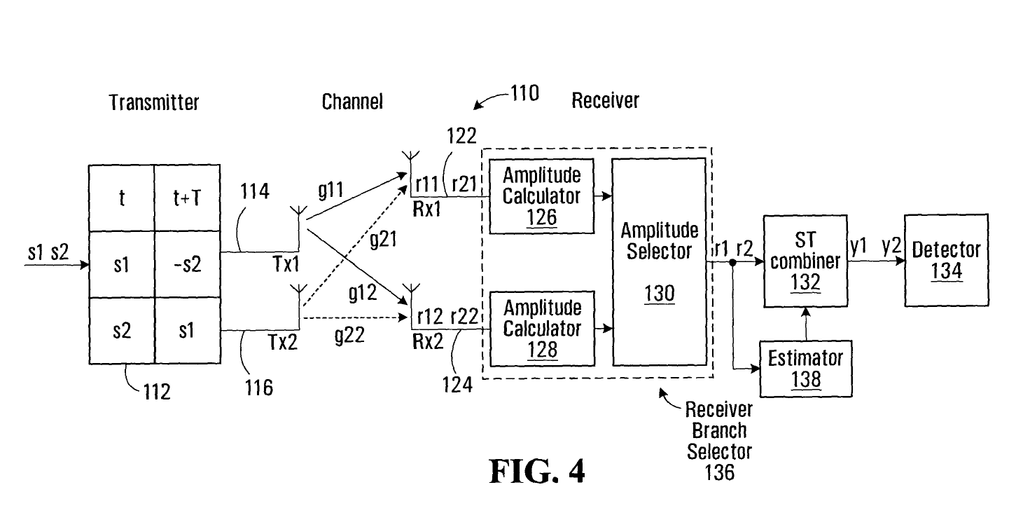

FIG. 4 is a block diagram of a system 110 in which an embodiment of the invention is implemented. The transmitter includes an encoder 112 that is operatively coupled to two antennas Tx1 114, Tx2 116. The transmitter antennas Tx1 114, Tx2 116 transmit communication signals through a wireless communication medium to a receiver.

The receiver has two receiver branches comprising two antennas Rx1 122, Rx2 124, which are operatively coupled to two received signal amplitude calculators 126, 128 respectively. A amplitude selector 130 is operatively coupled to the amplitude calculators 126, 128, and also to an ST combiner 132 and a channel estimator 138. The two amplitude calculators 126, 128 and the amplitude selector 130 comprise a receiver branch selector 136. The ST combiner 132 is operatively coupled to a detector 134.

Embodiments of the invention may be implemented in systems in which transmitters and receivers include fewer, further, or different components, with similar or different interconnections, than those explicitly shown in FIG. 4. For example, although the transmitter and receiver of the system 110 have two antennas, principles of the invention are applicable to systems in which transmitters and/or receivers have more than two antennas. It should therefore be appreciated that the system 110, as well as the content of the subsequent drawings, are intended solely for illustrative purposes. The present invention is in no way limited to the example embodiments which have been specifically shown in the drawings and described in detail herein.

The antennas Rx1 122 and Rx2 124 convert electromagnetic signals received through a wireless communication medium into electrical signals. Many types of antenna are known to those skilled in the art of wireless communications, and other types of antenna to which the selection schemes disclosed herein would be applicable may be developed in the future.

The amplitude calculators 126, 128 of the receiver branch selector 136 process communication signals received by the antennas 122, 124, and may be implemented in hardware, software for execution by a processor, or some combination thereof. Software supporting the functions of the amplitude calculators 126, 128 may be stored in a memory (not shown) and executed by a processor such as a microprocessor, a microcontroller, a Digital Signal Processor (DSP), an Application Specific Integrated Circuit (ASIC), a Programmable Logic Device (PLD), and/or a Field Programmable Gate Array (FPGA), for example.

The amplitude selector 130 of the receiver branch selector 136, the ST combiner 132, the channel estimator 138 and the detector 134 may similarly be implemented in hardware, software, or some combination thereof.

In operation, according to the STSoS technique, the amplitude calculators 126, 128 of the receiver branch selector 136 calculate amplitude values from respective receiver branches, and the amplitude selector 130 of the receiver branch selector 136 selects the receiver branch with the largest amplitude and forwards signals r₁, r₂ received on the selected receiver to the ST combiner 132 and the channel estimator 138 for processing. The ST combiner 132 gets channel information from the channel estimator 138 then uses the channel information to weight r₁ and r₂ to obtain y₁ and y₂. After the ST combiner 132, the detector 134 extracts the sign of the real part of y₁ and y₂ and uses it to decide the symbols s₁ and s₂, respectively. By using only received signals from the selected branch, the receiver needs only one ST combiner 132 and one channel estimator 138 before data detection. Compared with MRC and conventional SC, which need L channel estimators and L ST combiners for all L receiver branches, STSoS offers a saving of L−1 channel estimators and L−1 ST combiners.

Although the amplitude calculators 126, 128 have been added to compute amplitude values, these include only simple arithmetic circuits, which are much less complex than estimators and combiners. A channel estimator, for example, might include components such as buffers to extract pilot symbols, computing circuits to estimate individual channel gains, and an interpolator to interpolate the channel gains. Furthermore, if the selection is done before RF processing paths or chains (it can be done either before the RF chains or after the RF chains), the result is a significant hardware saving on analog circuits, which are very expensive. Moreover, in STSoS, selection is done without channel information, so receiver performance does not rely on the accuracy of the channel estimation.

Both LLR-based and SNR-based selection combining schemes require knowledge of all the receiver branch fading gains in order to decide which branch to choose. This increases the receiver complexity. According to STSoS, the amplitude calculators 126, 128 of the receiver branch selector 136 calculate squared amplitudes as a measure of received signal amplitudes, and the branch providing the largest sum of squared amplitudes of the two received signals, i.e. |r_{1,i}|²+|r_{2,i}|², is selected by the amplitude selector 130 of the receiver branch selector 136. This scheme may appear to be similar to square-law combining, although square-law combining is restricted to noncoherent modulation. In one embodiment, the present invention is implemented in conjunction with coherent modulation.

One advantage of STSoS is that it does not require channel estimation to perform the selection. Hence, the receiver implementation is simpler than other selection schemes. Moreover, this new scheme provides comparable performance with SNR-based selection, as shown below.

Observe that

$$\begin{matrix}2 {\vert {r}_{1 , i} \vert}^{2} + 2 {\vert {r}_{2 , i} \vert}^{2} = {\vert {r}_{1 , i} + {r}_{2 , i} \vert}^{2} + {\vert {r}_{1 , i} - {r}_{2 , i} \vert}^{2} \\ = {\vert {g}_{1 , i} ( {s}_{1} - {s}_{2} ) + {g}_{2 , i} ( {s}_{1} + {s}_{2} ) + {n}_{1 , i} + {n}_{2 , i} \vert}^{2} + \\ {\vert {g}_{1 , i} ( {s}_{1} + {s}_{2} ) + {g}_{2 , i} ( {s}_{2} - {s}_{1} ) + {n}_{1 , i} - {n}_{2 , i} \vert}^{2}\end{matrix} \qquad ( 24 a )$$

and, observe further that s₁+s₂=±2 and s₁−s₂=0, or s₁+s₂=0 and s₂−s₁=±2, so that

$${\vert {r}_{1 , i} + {r}_{2 , i} \vert}^{2} + {\vert {r}_{1 , i} - {r}_{2 , i} \vert}^{2} = \{ \begin{matrix}{\vert \pm 2 {g}_{1 , i} + {n}_{1 , i} + {n}_{2 , i} \vert}^{2} + {\vert \pm 2 {g}_{2 , i} + {n}_{1 , i} - {n}_{2 , i} \vert}^{2} , & {s}_{1} = - {s}_{2} \\ {\vert \pm 2 {g}_{2 , i} + {n}_{1 , i} + {n}_{2 , i} \vert}^{2} + {\vert \pm 2 {g}_{1 , i} + {n}_{1 , i} - {n}_{2 , i} \vert}^{2} , & {s}_{1} = {s}_{2} .\end{matrix} \qquad ( 24 b )$$

Thus, selecting the branch having the maximum value of |r_{1,i}|²+|r_{2,i}|² is equivalent to selecting the branch with the maximum value of

|g_{1,i}+n₁^{e}|+|g_{2,i}+n₂^{e}|² (25)

where n₁^{e} and n₂² are independent, complex noise samples, each of variance σₙ²/2 in each of the real and imaginary components.

Note that when the SNR becomes large, STSoS selection is equivalent to selecting the branch with the maximum value of |g_{1,i}|²+|g_{2,i}|² because the noise terms in (25) become small. On the other hand, in SNR selection combining, selecting the antenna providing the largest aᵢ=|ĝ_{1,i}|² +|ĝ_{2,i}|²/2σ_{ĝ}² is equivalent to selecting the antenna providing the largest |ĝ_{1,i}|²+|ĝ_{2,j}|² because the σ_{ĝ}_{²} is the same over all the receiver branches. Since the channel gain estimate depends on the SNR, with a large SNR value, one has ĝ_{j,i}→g_{j,i}, j=1, 2. As a result, the SNR selection is equivalent to selecting the branch with the maximum value of |g_{1,i}|²+|g_{2,i}|² as well. Thus, when the SNR becomes large, STSoS selection becomes equivalent to SNR-based selection.

Observe further that the noise affecting the branch selection is effectively reduced by 3 dB in the STSoS combiner. Also note that, when the SNR becomes small, both STSoS selection and SNR selection become dominated by noise terms, e.g., nⱼ^{e}, j=1, 2 for STSoS selection and estimation error for SNR selection. Both these terms are Gaussian distributed such that the BER performances of both selection methods approach 0.5. As a result, the BER difference between the two methods is still non-distinguishable.

The simulation results discussed below show that STSoS selection has essentially the same performance as SNR-based selection.

Space-Time Sum-of-Magnitudes (STSoM) Selection

Another embodiment of the invention involves selection combining based on a sum of magnitudes of received signals. The receiver structure for STSoM is very similar to that of STSoS, which is shown in FIG. 4. The difference is that the amplitude calculators 126, 128 of the receiver branch selector 136 calculate a sum of magnitudes as a measure of received signal amplitude instead of a sum of squares. Since it is generally easier to extract signal amplitudes than squared amplitudes, the STSoM method may be considered a further simplified implementation of STSoS.

Thus, whereas STSoS selection combining selects a receiver branch which provides the largest sum of |r_{1,i}|²+|r_{2,i}|², STSoM selection combining selects the branch with the largest sum, |r_{1,i}|+|r_{2,i}|. Similar to STSoS selection, this scheme, called STSoM selection, does not require channel estimation. It is simpler than STSoS selection because the receiver only needs to obtain the amplitudes of the two received signals r_{1,i} and r_{2,i}, and then take the sum. The simulation results in the following section show that it has only slightly poorer BER performance than STSoS and SNR selection.

### Numerical Results and Discussion

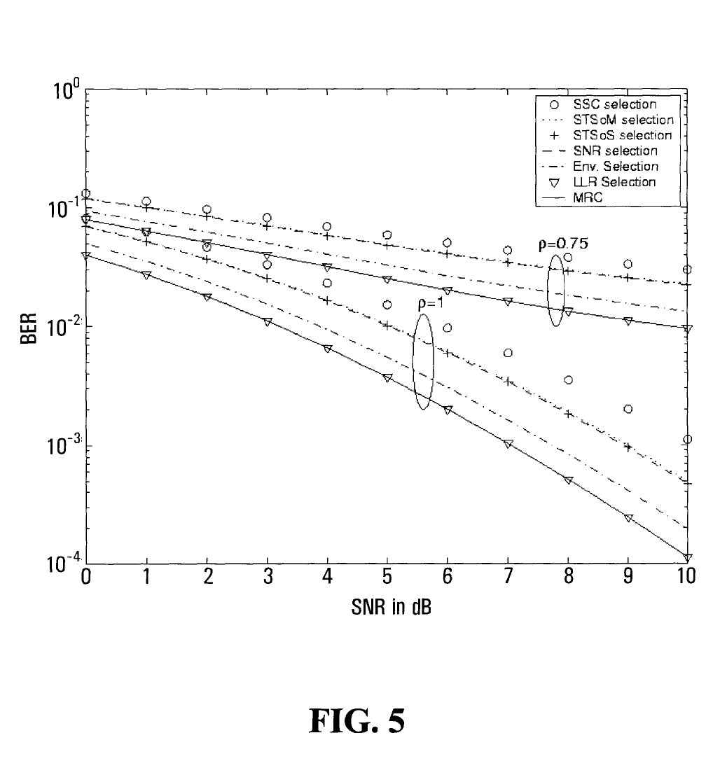

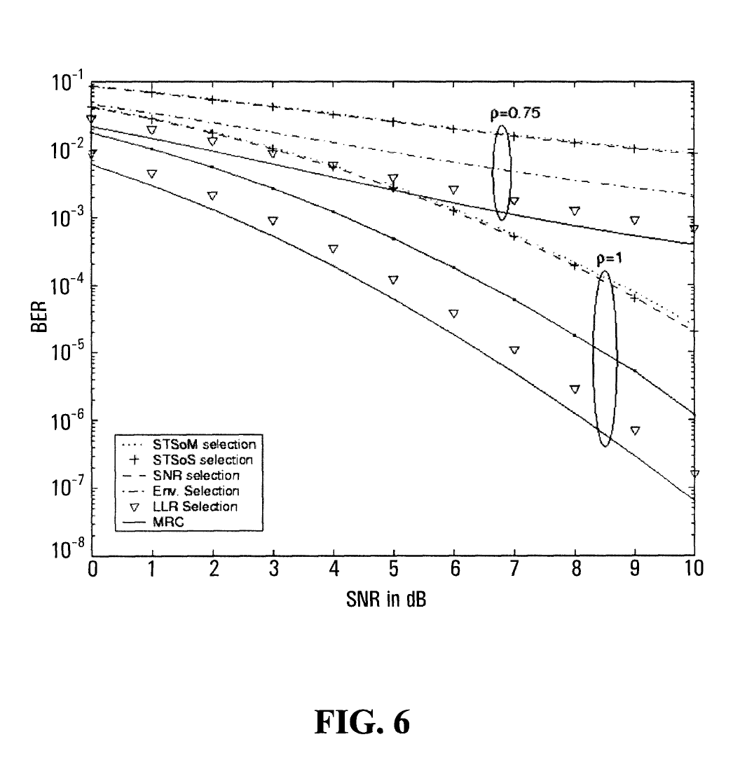

The BER results discussed below are functions of γ̅_{c}, which is in turn a function of ρ and γ̅. FIGS. 5-6 show plots of the average BER versus SNR per bit for the different selection diversity schemes in a flat Rayleigh fading channel with perfect channel estimation and cross-correlation 0.75, for a 2 by 2 system and a 2 by 4 system, respectively. The envelope-selection, STSoS selection, and STSoM selection schemes are evaluated by computer simulation. As expected, these results show that, in all cases, the BER increases with increasing fading estimation error (decreasing value of ρ).

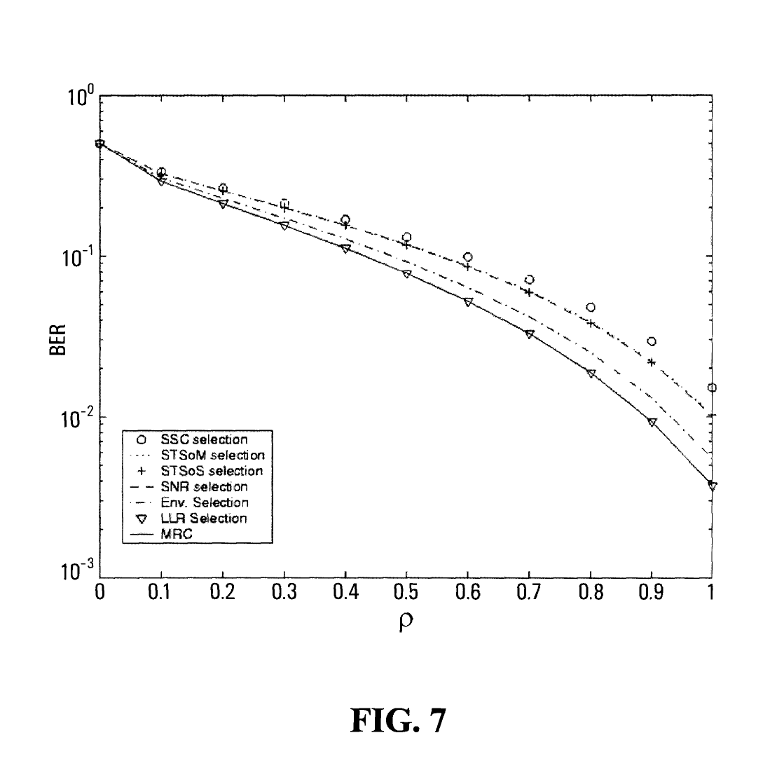

The performance results shown in FIGS. 5 and 6, and similarly FIGS. 7-10, were obtained using an example set of operating conditions. Different results may be obtained using different simulation parameters or actual implementations of embodiments of the invention.

It is observed in FIG. 5, that the performances of LLR selection and MRC are the same for dual diversity. The performances are, indeed, identical because, for MRC the sign of the combiner output Re(y_{1,1})+Re(y_{1,2}) is determined by the maximum of |Re(y_{1,i})|, which coincides with the LLR selection rule. It is also observed in FIG. 5 that the performances of STSoS selection and SNR selection are the same, at least to graphical accuracy. The STSoM selection scheme performs almost as well as the STSoS and SNR selection schemes although it is simpler than both to implement. As does STSoS selection, STSoM selection chooses the best branch without requiring any channel estimation. The envelope-LLR selection scheme, which does require channel estimation of all the channels, performs better than the STSoS, STSoM and SNR selection schemes but not as well as the LLR and MRC designs. The SSC selection offers the poorest performance, in exchange for its simplicity, as expected.

FIG. 6 shows a plot of average BER as a function of SNR per bit for the various selection schemes used in 4-fold diversity with perfect channel estimation and ρ=0.75. There are a number of interesting observations. First, MRC and LLR are not the same, and MRC outperforms LLR, as expected. Second, the LLR selection outperforms envelope-selection, as one expects. Third, the envelope-selection outperforms STSoS and STSoM. Fourth, the performances of SNR and STSoS selection are the same, as they were for the dual-branch case. This is a significant result. In order to implement SNR selection, the gains of all the diversity channels must be estimated. No channel estimation is required to implement STSoS selection. The demodulation involves channel estimation according to (2a), but in the case of STSoS only two channel gains need to be estimated, while in the case of SNR selection, 2 L channel gains must be estimated to implement the branch selection. In further study, SNR and STSoS schemes have been compared for L=8 and L=12 in W. Li, “Effects of channel estimation errors on receiver selection combining diversity for Alamouti MIMO systems,” M.S. thesis, Univ. of Alberta, Edmonton, Canada, 2005, which is hereby incorporated by reference in its entirety. In all cases, the performances are the same.

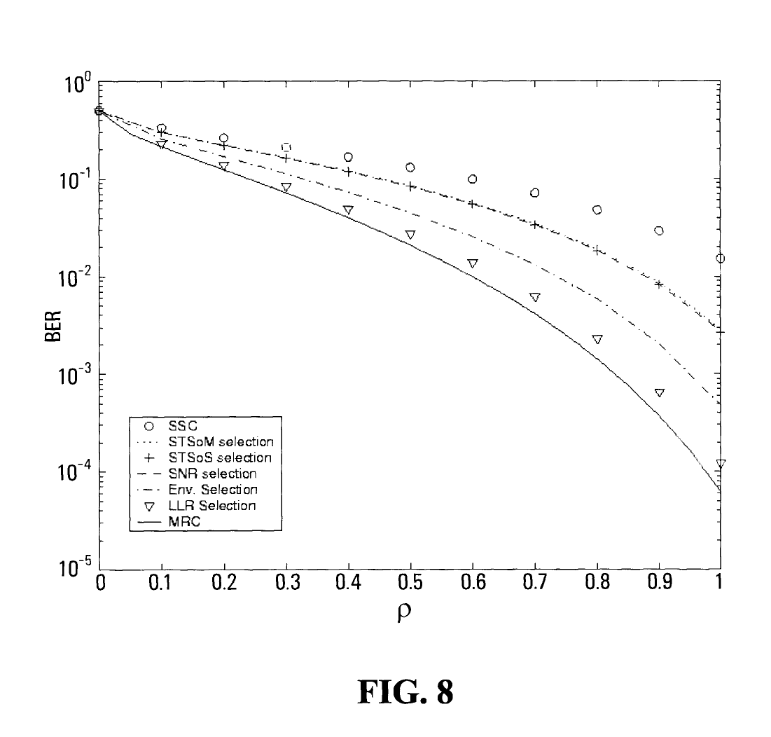

FIGS. 7-8 show plots of average BER as a function of ρ for the various selection schemes with an SNR of 5 dB per bit for a 2 by 2 system and a 2 by 4 system, respectively. Observe from both figures that, with poor channel estimation, i.e., ρ→0, all the BER curves converge to 0.5. At this point, the system is only affected by random noise and offers the worst BER performance. With increasing ρ, there is a decrease of error rate for all the selection schemes. When ρ=1, systems with various selection schemes reach the best performance, where the BER values match the values in FIGS. 5-6 at the ρ=1 and γ̅ₕ=5 dB point.

FIGS. 5-8 show the average BER vs. SNR for specific, constant values of ρ. These results show clearly the performance differences between the selection schemes. They are also representative of a situation where the receiver electronics reach a limit and cannot provide a better estimate of the channel gain. On the other hand, many practical estimators will show a dependence on SNR, i.e. give better estimates as the SNR increases. In these cases, a larger SNR value leads to a better channel estimate, which means a higher value of ρ.

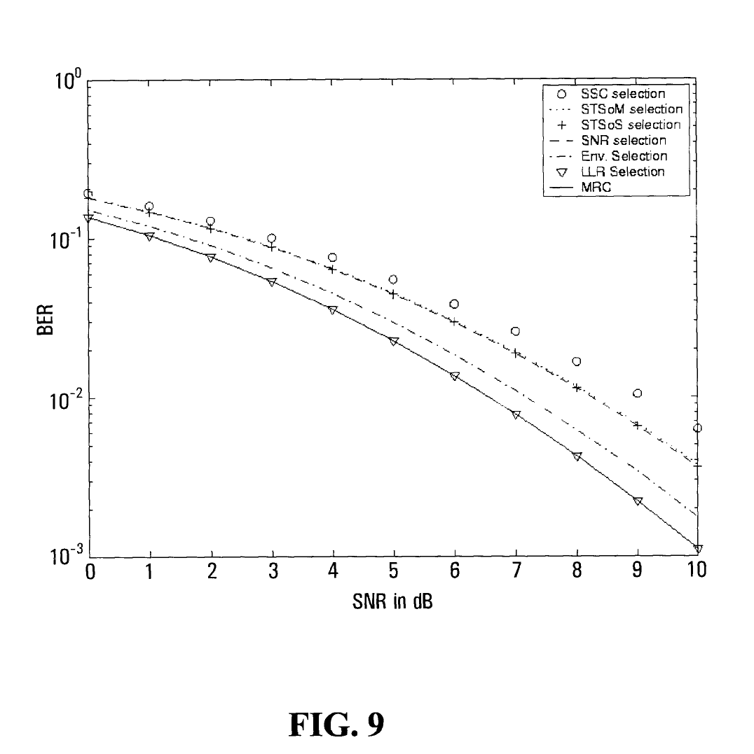

To show this effect on BER, we consider PSAM as an example. We assume that a sinc interpolator with a Hamming window is used to interpolate fading estimates, with a frame size of 14, and normalized Doppler shift of 0.03. FIG. 9 shows the average BER versus SNR from 0 dB to 10 dB with L=2. Since ρ is also a function of the symbol location, that is, with the same SNR value, in the same frame, data symbols located at different places will experience different ρ values, we give the BER of the 3rd data symbol in a frame as an example. Computed from (33), the value of ρ for this PSAM system varies from 0.513 to 0.913 as the SNR varies from 0 dB to 10 dB.

Similar to the results in FIGS. 5-6, in FIG. 9, MRC and LLR selection still have the best performance, then envelope-LLR selection outperforms SNR and STSoS selection, which in turn slightly outperform STSoM selection. The simplest selection scheme, SSC selection, has the worst BER performance. Again, the performance of SNR and STSoS schemes are indistinguishable.

FIG. 6 shows similar results for 4-fold diversity. In this case, MRC outperforms LLR selection, but SNR and STSoS selection again have the same performance, which is marginally better than STSoM selection.

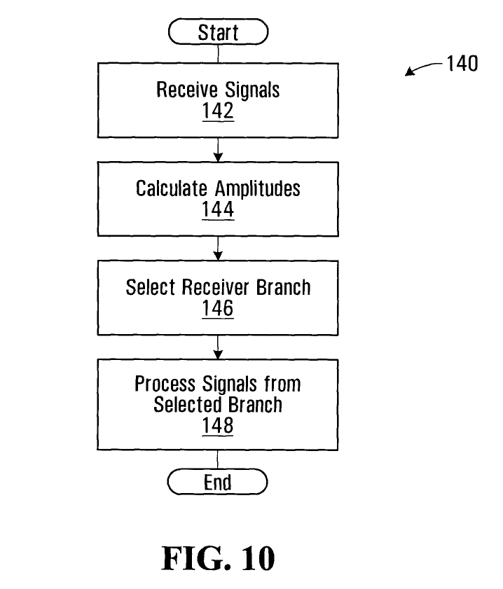

Embodiments of the invention have been described above primarily in the context of systems or apparatus. FIG. 10 is a flow chart illustrating a method according to another embodiment of the invention.

The method 140 begins at 142 when communication signals are received. Amplitudes of the received signals on each of a plurality of receiver branches are calculated at 144. One branch is selected at 146 based on relative amplitudes. According to a preferred embodiment, the branch for which received signals have the highest amplitude is selected. Signals received through the selected branch are provided for further processing, such as ST combining and signal detection, at 148.

FIG. 10 is representative of one example embodiment of the invention. Other embodiments may involve further or fewer operations than those explicitly shown, which may be performed in a similar or different order.

Various ways of performing the operations shown in FIG. 10, and additional operations which may be performed in some embodiments, will be apparent from the foregoing system and apparatus descriptions. Other variations of the method 140, some of which may be apparent to those skilled in the art, are also possible.

In the embodiments described above, a single receive branch/signal is selected. More generally, the methods can be used to select N signals from a plurality M of signals received via respective antennas containing a length L space-time block code, where M≧2, M>N≧1, L≧2. In such an application, a respective moment of a raw signal plus noise sample of the signal received on the receive antenna for each of L symbol intervals of a block code duration is determined, and these moments are summed to produce a respective moment sum. Then, the N signals that have the N largest moment sums are selected for subsequent communication signal processing. In the particular embodiments described, N is 1, but it can be 2, or some other number. A block diagram of this more generalized implementation is shown in FIG. 12.

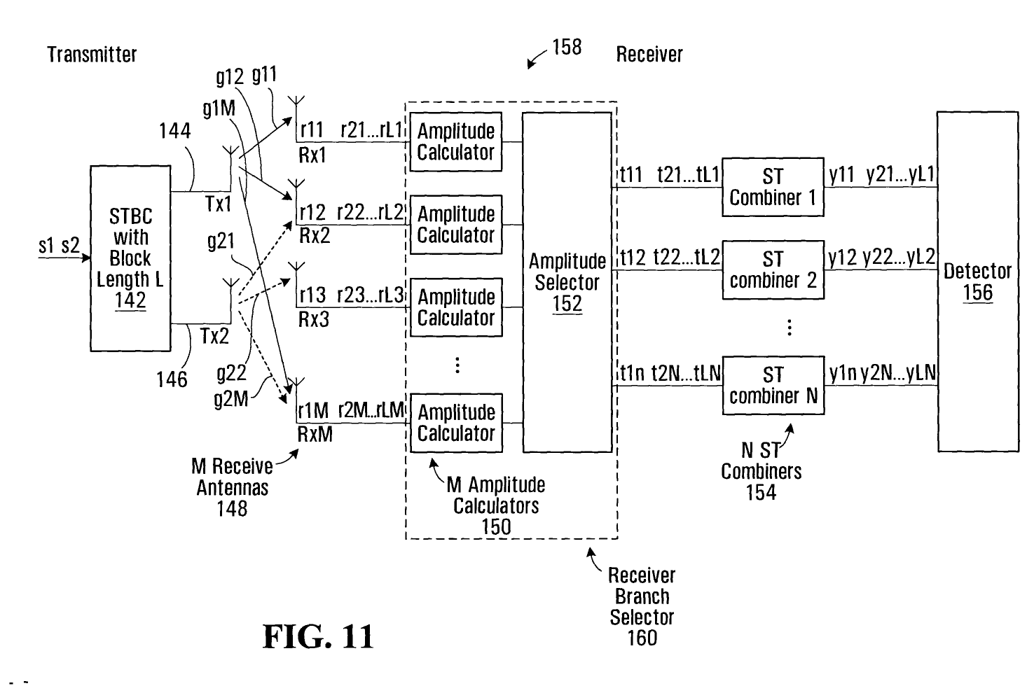

FIG. 11 is a block diagram of a system 158 in which an embodiment of the invention is implemented. The transmitter includes an STBC encoder 142 with block length L that is operatively coupled to two antennas Tx1 144, Tx2 146. The transmitter antennas Tx1 144, Tx2 146 transmit communication signals through a wireless communication medium to a receiver.

The receiver has M receiver branches, comprising M receive antennas Rx1, Rx2, Rx3, . . . , RxM 148. The M receive antennas are operatively coupled to M received signal amplitude calculators 150 of a receiver branch selector 160 respectively. The M received signal amplitude calculators 150 of the receiver branch selector 160 are also operatively coupled to an amplitude selector 152, which is also part of the receiver branch selector 160. The amplitude selector 152 of the receiver branch selector 160 is also operatively coupled to N ST combiners 154. The N ST combiners 154 are operatively coupled to a detector 156.

Embodiments of the invention may be implemented in systems in which transmitters and receivers include fewer, further, or different components, with similar or different interconnections, than those explicitly shown in FIG. 11. For example, although the transmitter of the system 158 has two antennas, principles of the invention are applicable to systems in which transmitters have more than two antennas. It should therefore be appreciated that the system 158 is intended solely for illustrative purposes.

Like the receive antennas Rx1 122 and Rx2 124 shown in FIG. 4, the M receive antennas 148 shown in FIG. 11 convert electromagnetic signals received through a wireless communication medium into electrical signals. Many types of antenna are known to those skilled in the art of wireless communications, and other types of antenna to which the selection schemes disclosed herein would be applicable may be developed in the future.

The M amplitude calculators 150 of the receiver branch selector 160 process communication signals received by the M receive antennas 148, and may be implemented in hardware, software for execution by a processor, or some combination thereof. Software supporting the functions of the M amplitude calculators 150 of the receiver branch selector 160 may be stored in a memory (not shown) and executed by a processor such as a microprocessor, a microcontroller, a Digital Signal Processor (DSP), an Application Specific Integrated Circuit (ASIC), a Programmable Logic Device (PLD), and/or a Field Programmable Gate Array (FPGA), for example.

The amplitude selector 152 of the receiver branch selector 160, the N ST combiners 154, and the detector 156 may similarly be implemented in hardware, software, or some combination thereof.

In operation, the M amplitude calculators 150 of the receiver branch selector 160 shown in FIG. 11 operate in the same manner as the amplitude calculators 126, 128 of the receiver branch selector 136 shown in FIG. 4. The amplitude selector 152 of the receiver branch selector 160 shown in FIG. 11 operates similarly to the amplitude selector 130 of the receiver branch selector 136 shown in FIG. 4, however rather than selecting a single receiver branch for further signal processing, the amplitude selector 152 selects N of the M receiver branches with the largest amplitude values, as determined by the M amplitude calculators 150, and forwards signals received on the selected receivers to the N ST combiners 154 for processing. By using only received signals from the selected branches, the receiver needs only N ST combiners 154 and N channel estimators (not shown) before data detection.

In some implementations the M amplitude calculators 150 of the receiver branch selector 160 are adapted to calculate squared amplitudes as a measure of received signal amplitudes in order to implement STSoS.

In some implementations the M amplitude calculators 150 of the receiver branch selector 160 are adapted to calculate a sum of magnitudes as a measure of received signal amplitude in order to implement STSoM.

Like the amplitude calculators 126, 128 shown in FIG. 4, the M amplitude calculators 150 of the receiver branch selector 160 shown in FIG. 11 include only simple arithmetic circuits, which are much less complex than estimators and combiners.

New antenna or receiver branch selection schemes, STSoS selection diversity and STSoM selection diversity, provide almost the same performance as SNR selection, but with much simpler implementations. In summary, the new selection schemes offer great hardware savings on ST combiners, channel estimators, and possibly RF chains, reduced power consumption, and as a result much simpler and more versatile receiver structures. Moreover, surprisingly, STSoS offers the same error probability performance as the method. The simpler STSoM method incurs only a 0.6 dB power loss when SNR=10 dB, compared to the SC method with two receiver antennas. The new selection schemes, for Alamouti transmission systems in some embodiments, are powerful solutions for reducing product construction cost and operating power consumption, in wideband wireless systems with multiple receiver antennas for instance.

What has been described is merely illustrative of the application of principles of embodiments of the invention. Other arrangements and methods can be implemented by those skilled in the art without departing from the scope of the present invention.

For example, STSoS and STSoM as described above select a receiver chain corresponding to the highest amplitude received signals. In order to limit receiver branch switching when amplitudes are not significantly different, a selected branch could be switched only when received signal amplitudes differ by more than a threshold amount. The threshold might be either predetermined or configurable, and defined as an absolute value or relative to calculated amplitude(s).

Division of functions between components of a communication signal receiver may also be different than explicitly shown in the drawings. For instance, an apparatus or system for selecting a receiver branch or signal path may include an amplitude selector and separate calculators, or a single component, such as the receiver branch selector shown in FIG. 4, which is configured to calculate signal amplitudes and select a signal path based on the calculated amplitudes.

The designation of antennas as receiver antennas or transmitter antennas in the foregoing description is not intended to imply that an antenna may only transmit or receive communication signals. Antennas used to transmit communication signals may also receive communication signals.

In addition, although described primarily in the context of methods and systems, other implementations of the invention are also contemplated, as instructions stored on a machine-readable medium, for example.

While the embodiments described have focussed on using the sum of squares of raw signal plus noise samples, more generally any appropriate sum of moments (power) of the signal plus noise samples can be employed taken over the STBC block length.

The methods and systems described above apply to other modulation schemes than just BPSK; for example, they can be applied to MPSK, coherent and incoherent modulations formats, differential modulation formats to name a few specific examples.

### APPENDIX A

### Derivation of ρ

### A. Fading Estimation in PSAM

We assume that PSAM is used for channel estimation. The PSAM frame format is similar to that considered in FIG. 2 of J. K. Cavers, “An analysis of pilot symbol assisted modulation for Rayleigh fading channels,” IEEE Trans. Veh. Technol., vol. 40, no. 11, pp. 686-693, 1991, which is hereby incorporated by reference in its entirety, where pilot symbols are inserted periodically into the data sequence. Since there are two Tx antennas and an Alamouti scheme is employed, we consider two consecutive pilot symbols are transmitted together between data symbols. Under the assumption that the fading gain remains constant over two consecutive symbol intervals, N/2 clusters, each with 2 symbols, are formatted into one frame of N symbols, where N is an even number, with the first two pilot symbols (n=0) followed by N−2 data symbols (1≦n≦N/2−1). The composite signal is transmitted over 2 L flat, Rayleigh fading channels. At the receiver, after matched filter detection, the pilot symbols are extracted and interpolated to form an estimate of the channel in the following manner.

Rewrite (1) to include the above assumptions as

r_{1,i,k}ⁿ=g_{1,i,k}ⁿs_{1,i,k}ⁿ+g_{2,i,k}ⁿs_{2,i,k}ⁿ+n_{1,i,k}ⁿ (26a)

r_{2,i,k}ⁿ=g_{1,i,k}ⁿs_{2,i,k}ⁿ+g_{2,i,k}ⁿs_{1,i,k}ⁿ+n_{2,i,k}ⁿ (26b)

where r_{1,i,k}ⁿ denotes the 1st received symbol at the nth symbol cluster of the kth data frame in the ith receiver branch, and similarly for the fading gain g and noise n. Since the pilot symbols are known to the receiver, without loss of generality, we assume that the two pilot symbols at the first cluster (n=0) of the frame have the values +1 and −1, respectively. Then for the two received pilot symbols, (26a) becomes

r_{1,i,k}⁰=g_{1,i,k}⁰−g_{2,i,k}⁰+n_{1,i,k}⁰ (27a)

r_{2,i,k}⁰=g_{1,i,k}⁰+g_{2,i,k}⁰+n_{2,i,k}⁰ (27b)

Adding (27a) and (27b), we obtain the estimate of g_{1,i,k}⁰ as

$${\hat{g}}_{1 , i , k}^{0} = {g}_{1 , i , k}^{0} + \frac{{n}_{1 , i , k}^{0} + {n}_{2 , i , k}^{0}}{2} . \qquad ( 28 a )$$

Subtracting (27a) from (27 b) generates

$${\hat{g}}_{2 , i , k}^{0} = {g}_{2 , i , k}^{0} + \frac{{n}_{2 , i , k}^{0} - {n}_{1 , i , k}^{0}}{2} . \qquad ( 28 b )$$

The fading at the nth symbol (1≦n≦N/2−) in the kth frame of the ith branch is estimated from 2K pilot symbols of K adjacent frames with pilot symbols from

$${k}_{1} = - ⌊ \frac{K - 1}{2} ⌋$$

previous frames and to

$${k}_{2} = ⌊ \frac{K}{2} ⌋$$

subsequent frames. These estimates are given by

$$\begin{matrix}\begin{matrix}{\hat{g}}_{1 , i , k}^{n} = {\sum }_{k = - {k}_{1}}^{{k}_{2}} {h}_{k}^{n} {\hat{g}}_{1 , i , k}^{0} \\ = {\sum }_{k = - {k}_{1}}^{{k}_{2}} {h}_{k}^{n} ( {g}_{1 , i , k}^{0} + \frac{{n}_{1 , i , k}^{0} + {n}_{2 , i , k}^{0}}{2} )\end{matrix} & ( 29 a ) \\ \begin{matrix}{\hat{g}}_{2 , i , k}^{n} = {\sum }_{k = - {k}_{1}}^{{k}_{2}} {h}_{k}^{n} {\hat{g}}_{2 , i , k}^{0} \\ = {\sum }_{k = - {k}_{1}}^{{k}_{2}} {h}_{k}^{n} ( {g}_{2 , i , k}^{0} + \frac{{n}_{2 , i , k}^{0} - {n}_{1 , i , k}^{0}}{2} ) ,\end{matrix} \\ n = 1 , … \frac{N}{2} - 1 & ( 29 b )\end{matrix}$$

where hₖⁿ is the interpolation coefficient for the nth data symbol in the kth frame.

### B. Derivation of R_{c}

In an omni-directional scattering Rayleigh fading channel, the above-identified J. K. Cavers reference states that the autocorrelation of the real part of the fading gain is

R(τ)=σ_{g}²J₀(2πf_{D}τ). (30)

Since calculation of the correlations for the data symbols is the same at all branches, we drop the subscripts {1,i} and {2,i} in (28), (29). Then, combining (28), (29) with (4a), (30), we have

$$\begin{matrix}{R}_{c} = E [ {g}_{Ik}^{n} {\hat{g}}_{Ik}^{n} ] = {\sum }_{k = - {k}_{1}}^{{k}_{2}} {h}_{k}^{n} E [ {g}_{Ik}^{n} ( {g}_{Ik}^{0} + \frac{{n}_{1 , k}^{0} + {n}_{2 , k}^{0}}{2} ) ] \\ = {\sum }_{k = - {k}_{1}}^{{k}_{2}} {σ}_{g}^{2} {h}_{k}^{n} {J}_{0} ( 2 π {f}_{D} \vert kN - 2 n \vert {T}_{s} ) .\end{matrix} \qquad ( 31 )$$

C. Derivation of σ_{ĝ}²

From (28) and (29), the variance of ĝ can be derived as

$$\begin{matrix}{σ}_{\hat{g}}^{2} = \frac{1}{2} E [ {\hat{g}}_{k}^{n} {\hat{g}}_{k}^{{n}^{*}} ] \\ = \frac{1}{2} E [ {\sum }_{k = - {k}_{1}}^{{k}_{2}} {h}_{k}^{n} ( {g}_{1 , i , k}^{0} + \frac{{n}_{1 , i , k}^{0} + {n}_{2 , i , k}^{0}}{2} ) \\ {\sum }_{k = - {k}_{1}}^{{k}_{2}} {h}_{k}^{n} ( {g}_{1 , i , k}^{0 {,}^{*}} + \frac{{n}_{1 , i , k}^{0 {,}^{*}} + {n}_{2 , i , k}^{0 {,}^{*}}}{2} ) ] \\ = {\sum }_{k = - {k}_{1}}^{{k}_{2}} {\sum }_{m = - {k}_{1}}^{{k}_{2}} {h}_{k}^{n} {h}_{m}^{n} {σ}_{g}^{2} {J}_{0} ( 2 π {f}_{D} \vert k - m \vert {NT}_{s} ) + \frac{{σ}_{n}^{2}}{2} {\sum }_{m = - {k}_{1}}^{{k}_{2}} {( {h}_{k}^{n} )}^{2} .\end{matrix} \qquad ( 32 )$$

### D. Derivation of ρ

From (6), using (31) and (32), we have

$$\begin{matrix}ρ = \frac{{R}_{c}^{2}}{{σ}_{g}^{2} {σ}_{\hat{g}}^{2}} \\ = \frac{{[ {\sum }_{k = - {k}_{1}}^{{k}_{2}} {h}_{k}^{n} {J}_{0} ( 2 π {f}_{D} \vert kN - 2 n \vert {T}_{s} ) ]}^{2}}{{\sum }_{k = - {k}_{1}}^{{k}_{2}} {\sum }_{m = - {k}_{1}}^{{k}_{2}} {h}_{k}^{n} {h}_{m}^{n} {J}_{0} ( 2 π {f}_{D} \vert k - m \vert {NT}_{s} ) + \frac{1}{\overline{γ}} {\sum }_{m = - {k}_{1}}^{{k}_{2}} {( {h}_{k}^{n} )}^{2}} .\end{matrix} \qquad ( 33 )$$

Note that ρ is a function of the type of interpolator, the data symbol location, the Doppler shift, the data frame length and the symbol interval. When a sinc interpolator, as described in Y.-S. Kim, C.-J. Kim, G.-Y. Jeong, Y.-J. Bang, H.-K. Park, and S. S. Choi, “New Rayleigh fading channel estimator based on PSAM channel sounding technique,” in Proc. IEEE Int. Conf. on Communications ICC 1997, June 1997, vol. 3, pp. 1518-1520, which is hereby incorporated by reference in its entirety, is used and a Hamming window is applied, the interpolation coefficients are given by

$${h}_{k}^{n} = sin c ( \frac{2 n}{N} - k ) [ 0.54 - 0.46 cos ( \begin{matrix}\frac{2 π ( 2 n - kN )}{KN - 1} + \\ \frac{2 π ⌊ \frac{KN}{2} ⌋}{KN - 1}\end{matrix} ) ] . \qquad ( 34 )$$

### APPENDIX B

### Derivation of (15)

Similar to the analysis in E. A. Neasmith and N. C. Beaulieu, “New results on selection diversity,” IEEE Trans. Commun., vol. 46, no. 5, pp. 695-703, May 1998, which is hereby incorporated by reference in its entirety, the BER for LLR receiver selection combining is

$${P}_{b} = {\sum }_{i = 1}^{L} Pr ( Re ( {y}_{1 , i} ) < 0 , ith branch selected ) . \qquad ( 35 )$$

Since Re(y_{1,i}) is proportional to Re(y′_{1,i}), conditioning Re(y′_{1,i}) in (13) on ĝ_{1,i} and ĝ_{2,i}, yields

$$\begin{matrix}{P}_{b} = {\sum }_{i = 1}^{L} Pr ( Re ( {y}_{1 , i}^{′} ) < 0 , ith branch selected ) \\ = L \cdot Pr ( Re ( {y}_{1 , 1}^{′} ) < 0 , 1 th branch selected ) \\ = L \cdot Pr ( Re ( {y}_{1 , 1}^{′} ) < 0 , \vert Re ( {y}_{1 , 1}^{′} ) \vert > {\vert Re ( {y}_{1 , i}^{′} ) \vert}_{∀ i , i \neq 1} ) \\ = L \cdot Pr ( - Re ( {y}_{1 , 1}^{′} ) > {\vert Re ( {y}_{1 , i}^{′} ) \vert}_{∀ i , i \neq 1} ) .\end{matrix} \qquad ( 36 )$$

Let rᵢ=Re(y′_{1,i}) and r₁=−Re(y′_{1,1}), then

P_{b}=L·∫₀^{∞}Pr(|rᵢ=Re(y′_{1,i})|_{∀i,i≠1}<r₁|r₁=−Re(y′_{1,1}))f_{R}(r₁)dr₁=L∫₀^{∞}[Pr(−r₁<rᵢ<r₁|r₁)]^{L-1}f_{R}(r₁)dr₁ (37)

where f_{R}(r₁) is the pdf of r₁. Since r₁=−Re(y′_{1,1}), f_{R}(r₁) is equal to fᵣ_{ᵢ}(−r₁), where fᵣ_{ᵢ}(x) is the pdf of rᵢ. From (10), one has that Re(y′_{1,i})_{∀i,i≠1} is Gaussian distributed with mean aᵢ and variance aᵢ / γ̅_{C}, when conditioned on

$${a}_{i} = \frac{{\vert {\hat{g}}_{1 , i} \vert}^{2} + {\vert {\hat{g}}_{2 , i} \vert}^{2}}{2 {σ}_{{g}^{}}^{2}} .$$

Averaging over aᵢ, the pdf of rᵢ is given by

$$\begin{matrix}{f}_{{r}_{i}} ( x ) = {\int }_{0}^{∞} {f}_{{r}_{i}} ( x \vert {a}_{i} ) {f}_{A} ( {a}_{i} ) d {a}_{i} \\ = {\int }_{0}^{∞} \sqrt{\frac{{\overline{γ}}_{c}}{2 π {a}_{i}}} exp [ - \frac{{{\overline{γ}}_{c} ( x - {a}_{i} )}^{2}}{2 {a}_{i}} ] {a}_{i} exp ( - {a}_{i} ) d {a}_{i} .\end{matrix} \qquad ( 38 )$$

Changing the variable of integration to z=\sqrt{a₁}, and using the result from eq. (3.472) in the above-identified I. S. Gradshteyn and I. M. Ryzhik reference, ∫₀^{∞}b²exp [symbol] −c₁1/b²−c₂b² [symbol] db= 1/4 {square root over (π/ c₂³ [symbol] 1+2\sqrt{c₁c₂} [symbol] exp(−2{square root over (c₁c₂), (38) can be )})}
simplified as

$$\begin{matrix}{f}_{{r}_{i}} ( x ) = A ( 1 + B \vert x \vert ) exp ( - B \vert x \vert + Cx ) & ( 39 a ) \\ A = \begin{matrix}\frac{\sqrt{{\overline{γ}}_{c} ( {\overline{γ}}_{c} + 2 )}}{{( {\overline{γ}}_{c} + 2 )}^{2}} & B = \sqrt{{\overline{γ}}_{c} ( {\overline{γ}}_{c} + 2 )} & C = {\overline{γ}}_{c} .\end{matrix} \\ & ( 39 b )\end{matrix}$$

Then, for the ith branch

$$\begin{matrix}\begin{matrix}Pr ( - {r}_{1} < {r}_{i} < {r}_{1} \vert {r}_{1} ) = {\int }_{- {r}_{1}}^{1} {f}_{{r}_{i}} ( x ) d x \\ = {m}_{7} + ( {m}_{1} - {m}_{2} {r}_{1} ) exp ( - {m}_{3} {r}_{1} ) - \\ ( {m}_{4} + {m}_{5} {r}_{1} ) exp ( - {m}_{6} {r}_{1} )\end{matrix} & ( 40 a ) \\ where \\ \begin{matrix}{m}_{1} = \frac{AC - 2 AB}{{( C - B )}^{2}} & {m}_{2} = \frac{AB}{B - C} \\ {m}_{3} = B - C & {m}_{4} = \frac{2 AB + AC}{{( B + C )}^{2}} \\ {m}_{5} = \frac{AB}{B + C} & {m}_{6} = B + C \\ {m}_{7} = \frac{4 {AB}^{3}}{{( {B}^{2} - {C}^{2} )}^{2}} . & \end{matrix} & ( 40 b )\end{matrix}$$

Combining (37), (38) and (40), the final expression for the BER is obtained as

$$\begin{matrix}{P}_{b} = L {\int }_{0}^{∞} [ {m}_{7} + ( {m}_{1} - {m}_{2} {r}_{1} ) exp ( - {m}_{3} {r}_{1} ) - \\ { ( {m}_{4} + {m}_{5} {r}_{1} ) exp ( - {m}_{6} {r}_{1} ) ]}^{L - 1} \times \\ A ( 1 + {Br}_{1} ) exp ( - {Br}_{1} - {Cr}_{1} ) d {r}_{1} \\ = L {\sum }_{n = 0}^{L - 1} {\sum }_{m = 0}^{L - 1 - n} {\sum }_{p = 0}^{n} {\sum }_{q = 0}^{m} {\sum }_{i = 0}^{1} ( \begin{matrix}L - 1 \\ n\end{matrix} ) ( \begin{matrix}L - 1 - n \\ m\end{matrix} ) ( \begin{matrix}n \\ p\end{matrix} ) ( \begin{matrix}m \\ q\end{matrix} ) \times \\ {AB}^{′} {m}_{1}^{n - p} {m}_{2}^{p} {m}_{4}^{m - q} {m}_{5}^{q} {m}_{7}^{L - 1 - n - m} \frac{{( - 1 )}^{m + p} ( p + q + i ) !}{{( {m}_{3} n + {m}_{6} m + B + C )}^{p + q + i + 1}} .\end{matrix} \qquad ( 41 )$$

### APPENDIX C

### Derivation of (22)

Following the above-identified A. A. Abu-Dayya and N. C. Beaulieu reference, the cdf of γ_{c} can be written as

$$F ( {γ}_{c} ) = \{ \begin{matrix}Pr ( {γ}_{c , 1} \leq {γ}_{c} ) Pr ( {γ}_{c , 2} \leq {γ}_{th} ) , & if {γ}_{c} < {γ}_{th} \\ Pr ( {γ}_{th} \leq {γ}_{c , 1} \leq {γ}_{c} ) + Pr ( {γ}_{c , 1} \leq {γ}_{c} ) Pr ( {γ}_{c , 2} \leq {γ}_{th} ) , & if {γ}_{c} \geq {γ}_{th} .\end{matrix} \qquad ( 42 )$$

From (12), both γ_{c,1} and γ_{c,2} have a chi-squared distribution given by

$$f ( {γ}_{c , i} ) = \frac{4 {γ}_{c , i}}{{\overline{γ}}_{c}^{2}} exp ( - \frac{2 {γ}_{c , i}}{{\overline{γ}}_{c}} ) , i = 1 , 2. \qquad ( 43 )$$

The pdf is obtained by differentiating the cdf in (42) with respect to γ_{c}

$$f ( {γ}_{c} ) = \{ \begin{matrix}[ 1 - ( \frac{2 {γ}_{th}}{{\overline{γ}}_{c}} + 1 ) exp ( - \frac{2 {γ}_{th}}{{\overline{γ}}_{c}} ) ] \frac{4 {γ}_{c}}{{\overline{γ}}_{c}^{2}} exp ( - \frac{2 {γ}_{c}}{{\overline{γ}}_{c}} ) , {γ}_{c} < {γ}_{th} \\ [ 2 - ( \frac{2 {γ}_{th}}{{\overline{γ}}_{c}} + 1 ) exp ( - \frac{2 {γ}_{th}}{{\overline{γ}}_{c}} ) ] \frac{4 {γ}_{c}}{{\overline{γ}}_{c}^{2}} exp ( - \frac{2 {γ}_{c}}{{\overline{γ}}_{c}} ) , {γ}_{c} \geq {γ}_{th} .\end{matrix} \qquad ( 44 )$$

### Then, the BER is

$$\begin{matrix}\begin{matrix}{P}_{b} = {\int }_{0}^{∞} Q ( \sqrt{2 {γ}_{c}} ) f ( {γ}_{c} ) d {γ}_{c} \\ = {K}_{3} {\int }_{0}^{∞} Q ( \sqrt{2 {γ}_{c}} ) \frac{4 {γ}_{c}}{{\overline{γ}}_{c}^{2}} exp ( - \frac{2 {γ}_{c}}{{\overline{γ}}_{c}} ) d {γ}_{c} + \\ {\int }_{{γ}_{th}}^{∞} Q ( \sqrt{2 {γ}_{c}} ) \frac{4 {γ}_{c}}{{\overline{γ}}_{c}^{2}} exp ( - \frac{2 {γ}_{c}}{{\overline{γ}}_{c}} ) d {γ}_{c} \\ = {K}_{1} - [ {K}_{1} ( \frac{2 {γ}_{th}}{{\overline{γ}}_{c}} + 1 ) - \frac{2 {γ}_{th} + {\overline{γ}}_{c}}{{\overline{γ}}_{c}} Q ( \sqrt{2 {γ}_{th}} ) + \\ \frac{\sqrt{{γ}_{th}}}{\sqrt{π} ( {\overline{γ}}_{c} + 2 )} exp ( - {γ}_{th} ) ] \\ exp ( - \frac{2 {γ}_{th}}{{\overline{γ}}_{c}} ) - {K}_{2} Q ( \sqrt{\frac{2 {γ}_{th} ( {\overline{γ}}_{c} + 2 )}{{\overline{γ}}_{c}}} )\end{matrix} & ( 45 a ) \\ {K}_{1} = \frac{\sqrt{{( {\overline{γ}}_{c} + 2 )}^{3}} - {\overline{γ}}_{c} \sqrt{{\overline{γ}}_{c}} - 3 \sqrt{{\overline{γ}}_{c}}}{2 \sqrt{{( {\overline{γ}}_{c} + 2 )}^{3}}} & ( 45 b ) \\ {K}_{2} = \frac{{\overline{γ}}_{c} + 3}{{\overline{γ}}_{c} + 2} \sqrt{\frac{{\overline{γ}}_{c}}{{\overline{γ}}_{c} + 2}} & ( 45 c ) \\ {K}_{3} = 1 - ( \frac{2 {γ}_{th}}{{\overline{γ}}_{c}} + 1 ) exp ( - \frac{2 {γ}_{th}}{{\overline{γ}}_{c}} ) . & ( 45 d )\end{matrix}$$

We claim:

1. Apparatus for selecting N communication signals from a plurality M of communication signals received via respective antennas containing a length L STBC (space-time block code), where M≧2, M≧N≧1, L≧2, the apparatus comprising a selector configured to:
for each receive antenna, determine a respective moment of a raw signal plus noise sample of the communication signal received on the receive antenna for each of L time intervals of a block code duration of the STBC and sum these moments to produce a respective moment sum; and
select the N communication signals that have the N largest moment sums for subsequent communication signal processing.

2. The apparatus of claim 1, wherein the selector comprises a plurality of moment calculators for respective connection to a plurality of communication signal receiver branches comprising the respective antennas, and configured to calculate the sums of moments of the communication signals received through the plurality of communication signal branches.

3. The apparatus of claim 1, wherein the communication signals received through an i^{th} communication signal receiver branch comprise diversity signals r_{j,i} received from transmitter antennas during j=1, . . . , L time intervals of an STBC block code duration, and wherein for each of the communication signal receiver branches, the moment sum is determined by summing |r_{j,i}| or |r_{j,i}|ⁿ for all the L time intervals, where n>=2.

4. The apparatus of claim 2, wherein the communication signals received through an i^{th} communication signal receiver branch comprise diversity signals r_{j,i} received from transmitter antennas during j=1, . . . , L time intervals of an STBC block code duration, and wherein for each of the communication signal receiver branches, the moment sum is determined by summing |r_{j,i}| or |r_{j,i}|ⁿ for all the L time intervals, where n>=2.

5. The apparatus of claim 1, wherein the STBC comprises an Alamouti code.

6. The apparatus of claim 1, wherein the communication signals comprise symbols generated using any one of: a coherent modulation scheme, a non coherent modulation scheme and a differential modulation scheme.

7. The apparatus of claim 1, wherein the communication signals comprise symbols generated using any one of: Binary Phase Shift Keying (BPSK) and MPSK.

8. The apparatus of claim 1, wherein the selector is further configured to determine whether a difference in amplitudes of respective communication signals received through the selected communication signal receiver branch and another communication signal receiver branch of the plurality of communication signal receiver branches exceeds a threshold, and to select the another communication signal receiver branch where the difference exceeds the threshold.

9. The apparatus of claim 1, wherein the subsequent communication signal processing comprises at least one of: space-time signal combining and signal detection.

10. The apparatus of claim 1 wherein M=2 and N=1.

11. The apparatus of claim 1 wherein N=2.

12. A communication device comprising:
a plurality of antennas for receiving space-time block code STBC encoded diversity communication signals from a plurality of transmitter antennas;
an apparatus according to claim 1 operatively coupled to the plurality of antennas; and
a communication signal processing path operatively coupled to the apparatus and configured to process the selected communication signals.

13. The communication device of claim 12, wherein the communication device comprises any one of: a communication network base station and a mobile terminal.

14. A communication system comprising:
a communication network comprising a network element; and
a wireless communication device configured for communicating with the network element,
at least one of the network element and the wireless communication device comprising the apparatus of claim 1.

15. A communication system comprising:
a communication network comprising a network element; and
a wireless communication device configured for communicating with the network element,
at least one of the network element and the wireless communication device comprising the communication device of claim 12.

16. The communication system of claim 14, wherein at least one of the network element and the wireless communication device comprises a plurality of transmitter antennas for transmitting the communication signals containing the length L space-time block code.

17. The communication system of claim 15, wherein at least one of the network element and the wireless communication device comprises the plurality of transmitter antennas.

18. A communication signal receiver branch selection method comprising:
for each of a plurality of receiver branches, determining a respective moment sum of signal plus noise samples of space-time diversity communication signals over a space-time block code length, each communication signal receiver branch being operatively coupled to a respective antenna for receiving communication signals from a plurality of transmitter antennas;
selecting at least one communication signal receiver branch from the plurality of communication signal receiver branches having the largest moment sum; and
providing communication signals from the selected communication signal receiver branch for subsequent communication signal processing.

19. The method of claim 18, further comprising, after selecting:
determining moment sums of communication signals received through the selected communication signal receiver branch and others of the plurality of communication signal receiver branches;
determining whether a difference in moment sums of communication signals received through the selected communication signal receiver branch and another communication signal receiver branch of the plurality of communication signal receiver branches exceeds a threshold; and
selecting the another communication signal receiver branch where the difference exceeds the threshold.

20. A machine-readable medium storing instructions which when executed perform the method of claim 19.
